(19) United States
(12) Patent Application Publication
(10) Pub. No.: US 2025/0282157 A1
(43) Pub. Date: Sep. 11, 2025

(54) SHEET CONVEYANCE APPARATUS AND IMAGE FORMING SYSTEM

(71) Applicant: CANON KABUSHIKI KAISHA, Tokyo (JP)

(72) Inventor: RYOSUKE KASAHARA, Ibaraki (JP)

(21) Appl. No.: 19/069,603

(22) Filed: Mar. 4, 2025

(30) Foreign Application Priority Data
Mar. 8, 2024 (JP) 2024-035940

(51) Int. Cl. B41J 11/00

(52) U.S. Cl. CPC B41J 11/006; B41J 11/0095

(57) ABSTRACT

A sheet conveyance apparatus includes a conveyance portion, a discharging support portion, a switching portion, a support portion, a feeding portion, a taking-in port, a multi-feeding detection portion, and a control portion. When the multi-feeding is detected based on the control portion determining that switching of the switching portion has been completed before a leading edge of the first sheet reaches the switching portion, the control portion switches the switching portion to the second position and guides the first sheet and the second sheet to the discharging support portion. When the multi-feeding is detected based on the control portion determining that the switching of the switching portion has not been completed before the leading edge of the first sheet reaches the switching portion, the control portion does not switch the switching portion and guides the first sheet and the second sheet to the second conveyance path.

### BACKGROUND OF THE INVENTION

### Field of the Invention

The present invention relates to a sheet conveyance apparatus that conveys sheets, and an image forming system.

### Description of the Related Art

For feeding sheets from a component such as a cassette or a tray, a separation pad or a separation roller is disposed for separating a sheet from others, one by one. However, if a following sheet sticks to a preceding sheet, multi-feeding may occur. In the multi-feeding, the preceding sheet is conveyed in a state where the following sheet overlaps with the preceding sheet. The multi-feeding may cause a defect in image formation, a jam, a failure, and the like. For this reason, Japanese Patent Application Publication No. H11-24506 proposes a configuration in which the conveyance is stopped if the multi-feeding of sheets (paper sheets) is detected.

However, the configuration proposed in Japanese Patent Application Publication No. H11-24506 and configured to stop the conveyance may reduce the productivity because the downtime occurs. Japanese Patent Application Publication No. 2002-333797 proposes a configuration in which if the multi-feeding is detected, the multi-fed sheets are discharged without performing the formation of images, and the images are formed on the following sheets. Japanese Patent Application Publication No. 2002-333797 also proposes a technique in which the multi-fed sheets are discharged to a predetermined discharging tray other than a specified sheet-discharging tray.

By the way, in recent years, an image forming system for commercial printing or the like includes a plurality of sheet feeding apparatuses connected with each other for ensuring an increased number of sheets which can be fed, and for increasing the time in which the printing can continue. Each of the sheet feeding apparatuses includes a sheet discharging tray, and a switching portion that switches the conveyance path to a path toward the sheet discharging tray. Thus, if the multi-feeding has occurred, the sheet feeding apparatus discharges multi-fed sheets to the sheet discharging tray, and does not feed the multi-fed sheets to an apparatus disposed downstream of the sheet feeding apparatus in the conveyance direction. In this manner, it is possible to prevent jam from occurring in the apparatus disposed downstream of the sheet feeding apparatus in the conveyance direction.

However, when the multi-feeding is detected, the multi-fed sheets may have already reached the switching portion that switches the conveyance path to a path toward the sheet discharging tray. In this case, it is not possible to discharge the multi-fed sheets to the sheet discharging tray. That is, in such a case, it is not possible to prevent the occurrence of jam.

An object of the present invention is to provide a sheet conveyance apparatus and an image forming system that can prevent the occurrence of jam even in a case where the multi-feeding is detected, and where the switching of the switching portion cannot be completed by the time when the leading edge of the first sheet reaches the switching portion.

### SUMMARY OF THE INVENTION

According to a first aspect of the present invention, a sheet conveyance apparatus includes a conveyance portion configured to convey a sheet, a discharging support portion configured to support the sheet discharged, a switching portion configured to be switched between a first position and a second position, the first position being a position at which the switching portion guides the sheet conveyed in a first conveyance path by the conveyance portion, to a second conveyance path, the second position being a position at which the switching portion guides the sheet conveyed in the first conveyance path by the conveyance portion, to a third conveyance path configured to convey the sheet to the discharging support portion, a support portion configured to support a plurality of sheets, a feeding portion configured to feed the sheets supported by the support portion to the first conveyance path, a taking-in port configured to receive the sheet and guide the sheet to the first conveyance path, a multi-feeding detection portion disposed upstream of the switching portion in a sheet conveyance direction and downstream of the support portion in the sheet conveyance direction and configured to detect multi-feeding in which a first sheet and a second sheet that follows the first sheet overlap with each other, and a control portion configured to control the switching portion. In a case where the multi-feeding is detected by the multi-feeding detection portion, based on the control portion determining that switching of the switching portion has been completed before a leading edge of the first sheet reaches the switching portion, the control portion is configured to switch the switching portion to the second position and guide the first sheet and the second sheet to the discharging support portion. In the case where the multi-feeding is detected by the multi-feeding detection portion, based on the control portion determining that the switching of the switching portion has not been completed before the leading edge of the first sheet reaches the switching portion, the control portion is configured not to switch the switching portion and guide the first sheet and the second sheet to the second conveyance path. In a case where multi-fed first and second sheets are conveyed into the first conveyance path through the taking-in port, the control portion is configured to switch the switching portion to the second position and guide the first sheet and the second sheet to the discharging support portion.

According to a second aspect of the present invention, a sheet conveyance apparatus connected to another sheet conveyance apparatus, the another sheet conveyance apparatus including a first conveyance portion configured to convey a sheet, a first discharging support portion configured to support the sheet discharged, and a first switching portion configured to be switched between a first position and a second position, the first position being a position at which the first switching portion guides the sheet conveyed in a first conveyance path by the first conveyance portion, to a second conveyance path, the second position being a position at which the first switching portion guides the sheet conveyed in the first conveyance path by the first conveyance portion, to a third conveyance path configured to convey the sheet to the first discharging support portion. The sheet conveyance apparatus includes a second conveyance portion configured to convey the sheet, a second discharging support portion configured to support the sheet discharged, a second switching portion configured to be switched between a third position and a fourth position, the third position being a position at which the second switching portion guides the sheet conveyed in a fourth conveyance path by the second conveyance portion, to a fifth conveyance path connected to the first conveyance path, the fourth position being a position at which the second switching portion guides the sheet conveyed in the fourth conveyance path by the second conveyance portion, to a sixth conveyance path configured to convey the sheet to the second discharging support portion, a support portion configured to support a plurality of sheets, a feeding portion configured to feed the sheets supported by the support portion to the fourth conveyance path, a multi-feeding detection portion disposed upstream of the second switching portion in a sheet conveyance direction and configured to detect multi-feeding in which a first sheet and a second sheet that follows the first sheet overlap with each other, and a control portion configured to control the second switching portion. In a case where the multi-feeding is detected by the multi-feeding detection portion, based on the control portion determining that switching of the second switching portion has been completed before a leading edge of the first sheet reaches the second switching portion, the control portion is configured to switch the second switching portion to the fourth position and guide the first sheet and the second sheet to the second discharging support portion. In the case where the multi-feeding is detected by the multi-feeding detection portion, based on the control portion determining that the switching of the second switching portion has not been completed before the leading edge of the first sheet reaches the second switching portion, the control portion is configured not to switch the second switching portion, switch the first switching portion to the second position, and guide the first sheet and the second sheet to the first discharging support portion.

According to a third aspect of the present invention, an image forming system includes the sheet conveyance apparatus, and an image forming apparatus configured to form an image on a sheet conveyed from the sheet conveyance apparatus.

Further features of the present invention will become apparent from the following description of exemplary embodiments with reference to the attached drawings.

### BRIEF DESCRIPTION OF THE DRAWINGS

FIG. 1A is a block diagram illustrating a schematic configuration of an image forming system of a first embodiment.

FIG. 1B is a schematic cross-sectional view illustrating the schematic configuration of the image forming system of the first embodiment.

FIG. 2A is a schematic cross-sectional view illustrating positions of sheets in a case where a single-side printing job is performed in the image forming system of the first embodiment.

FIG. 2B is a schematic cross-sectional view illustrating positions of sheets in a case where a double-side printing job is performed in the image forming system of the first embodiment.

FIG. 3 is a schematic cross-sectional view illustrating a sheet feeding apparatus of the first embodiment.

FIG. 4 is a block diagram illustrating a control portion of the image forming system of the first embodiment.

FIG. 5 is a block diagram illustrating a control portion of the sheet feeding apparatus of the first embodiment.

FIG. 6 is a block diagram illustrating control functions of the sheet feeding apparatus of the first embodiment.

FIG. 7 is a table illustrating a conveyance-route management table of the sheet feeding apparatus of the first embodiment.

FIG. 8 is a diagram illustrating a list of sheet information.

FIG. 9 is a flowchart illustrating conveyance control of the sheet feeding apparatus of the first embodiment.

FIG. 10 is a flowchart illustrating conveyance-path switch control of the sheet feeding apparatus of the first embodiment.

FIG. 11A is a diagram illustrating a case where the length of a sheet multi-fed in the sheet feeding apparatus is shorter than the distance between a multi-feeding detection sensor and a switching portion.

FIG. 11B is a diagram illustrating a case where the length of a sheet multi-fed in the sheet feeding apparatus is longer than the distance between the multi-feeding detection sensor and the switching portion.

FIG. 12 is a schematic cross-sectional view illustrating a case where multi-fed sheets are discharged to a sheet discharging tray in a feeding portion of the image forming system of the first embodiment.

FIG. 13 is a flowchart illustrating conveyance-path switch control of a sheet feeding apparatus of a second embodiment.

FIG. 14 is a time chart illustrating a relationship between a waveform detected by the multi-feeding detection sensor and the time.

### DESCRIPTION OF THE EMBODIMENTS

### First Embodiment

Hereinafter, a first embodiment for embodying the present invention will be described with reference to the accompanying drawings. In the first embodiment, the description will be made for a case where an ink-jet recording system is used as an image forming system 1.

### Ink-Jet Recording System

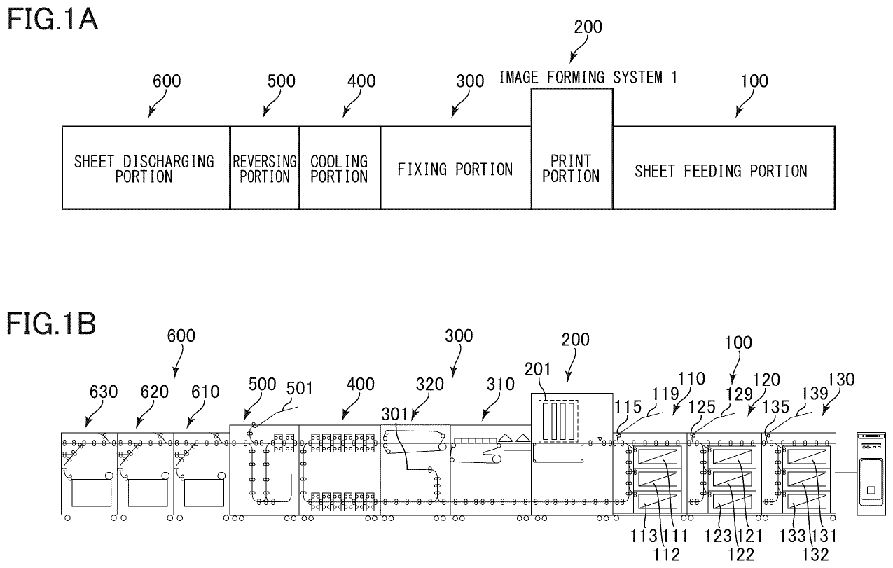

First, a schematic configuration of the image forming system 1 of the first embodiment will be described with reference to FIGS. 1A and 1B. FIG. 1A is a block diagram illustrating a schematic configuration of the image forming system of the first embodiment. FIG. 1B is a schematic cross-sectional view illustrating the schematic configuration of the image forming system of the first embodiment. The image forming system 1 is a sheet-fed ink-jet recording system that forms an ink image on a sheet or a paper sheet (that is, produces a recorded product) by using two liquids: reaction liquid and ink. In the present embodiment, the sheet is a plain paper sheet, a thin paper sheet, a thick paper sheet, or a coated paper sheet. However, the sheet is not limited to the above-described sheets, and may be another sheet or a sheet made of a material other than paper. In addition, in the present embodiment, feeding of sheets is referred to as sheet feeding, and discharging of sheets is referred to as sheet discharging. The material of the sheet is not necessarily limited to paper.

As illustrated in FIG. 1A, the image forming system 1 is constituted by six units: a sheet feeding portion 100, a print portion 200 that serves as an image forming apparatus, a fixing portion 300, a cooling portion 400, a reversing portion 500, and a sheet discharging portion 600.

As illustrated in FIG. 1B, in the sheet feeding portion 100 that serves as a feeding portion that feeds sheets in the present embodiment, three sheet feeding apparatus 110, sheet feeding apparatus 120, and sheet feeding apparatus 130 that serve as sheet conveyance apparatuses are connected (linked) with each other. The sheet feeding apparatus 110 is a unit that includes sheet feeding trays, and includes a first sheet-feeding tray 111, a second sheet-feeding tray 112, and a third sheet-feeding tray 113 that serve as a three-tier support portion. The first sheet-feeding tray 111, the second sheet-feeding tray 112, and the third sheet-feeding tray 113 store various types of printing sheets used in the print process. The sheet feeding apparatus 110 further includes a sheet discharging port 115 and a sheet discharging tray 119 that can be used as a destination to which an error sheet is sent. The error sheet is a sheet that cannot be normally conveyed to the print portion 200 when a jam occurs, a multi-fed sheet, or the like. Similarly, the sheet feeding apparatus 120 includes a first sheet-feeding tray 121, a second sheet-feeding tray 122, a third sheet-feeding tray 123, and a sheet discharging port 125. The first sheet-feeding tray 121, the second sheet-feeding tray 122, and the third sheet-feeding tray 123 constitute a three-tier support portion. Furthermore, the sheet feeding apparatus 130 includes a first sheet-feeding tray 131, a second sheet-feeding tray 132, a third sheet-feeding tray 133, and a sheet discharging port 135. The first sheet-feeding tray 131, the second sheet-feeding tray 132, and the third sheet-feeding tray 133 constitute a three-tier support portion.

The print portion 200 is a unit that performs printing on a sheet, which is used for printing a print image. The print portion 200 includes an ink-jet head 201 that serves as an image forming portion. The ink-jet head 201 constitutes an image forming portion that forms an image by performing a recording process (printing). In the recording process, the ink is ejected from a plurality of recording heads to a sheet that is being conveyed. The ink is ejected from above the sheet, and adheres to the sheet.

The fixing portion 300 is a unit that performs fixing control for fixing an image printed by the print portion 200, to a sheet. The fixing portion 300 includes a drying module 310 and a fixing module 320. The drying module 310 increases the fixability between the sheet and ink by blowing warm air on the sheet and reducing the liquid component of the ink adhered to the sheet. The fixing module 320 fixes the print image to the sheet by heating the sheet, by using a plurality of heater units. The fixing portion 300 includes a sheet discharging port 301 that can be used as a destination to which an error sheet is sent.

The cooling portion 400 is a unit that performs temperature control for returning the temperature of the sheet, heated by the fixing portion 300, to a normal temperature by cooling the sheet. The cooling portion 400 cools the sheet by using a plurality of fan units.

The reversing portion 500 is a unit that performs reverse control of a sheet by switch-backing the sheet that is being conveyed. For stacking the sheet on the next-stage sheet discharging portion 600, the reversing portion 500 performs the reverse control for switching the state of the sheet between a state where the sheet is to be stacked with a printed surface serving as an upper surface, and a state where the sheet is to be stacked with the printed surface serving as a lower surface. The reversing portion 500 includes a sheet discharging port 501 that can be used as a destination to which an error sheet is sent.

The sheet discharging portion 600 is a unit that stacks printed sheets and performs sheet discharging control. In the sheet discharging portion 600, three sheet discharging apparatus 610, sheet discharging apparatus 620, and sheet discharging apparatus 630 are connected (linked) with each other. The sheet discharging apparatus 610 includes a sheet discharging stacker 611 that supports and stacks printed sheets. In addition, the sheet discharging apparatus 610 includes a sheet discharging port 612 that can be used as a destination to which a printed sheet or an error sheet is sent. Similarly, the sheet discharging apparatus 620 includes a sheet discharging stacker 621 and a sheet discharging port 622, and the sheet discharging apparatus 630 includes a sheet discharging stacker 631 and a sheet discharging port 632.

The image forming system 1 is connected with a print server 70, and a print job is sent from the print server 70. Furthermore, the print server 70 can be used for checking the state of the image forming system 1, monitoring the print job, and performing the maintenance control. Thus, a user can operate the whole of various functions of the image forming system 1.

The ink-jet head 201 of the print portion 200 is a precision portion that requires precision control. For example, if a plurality of sheets is multi-fed to the ink-jet head 201 in a state where the sheets overlap with each other, the distance between the ink-jet head 201 and the multi-fed sheets cannot be kept properly, and the sheets may contact the ink-jet head 201. In this case, the ink-jet head 201 may be damaged by the sheets. For preventing the damage of the ink-jet head 201, it is necessary to remove the multi-fed sheets on the upstream side without conveying the multi-fed sheets to the print portion 200.

### Conveyance of Sheets in Image Forming System

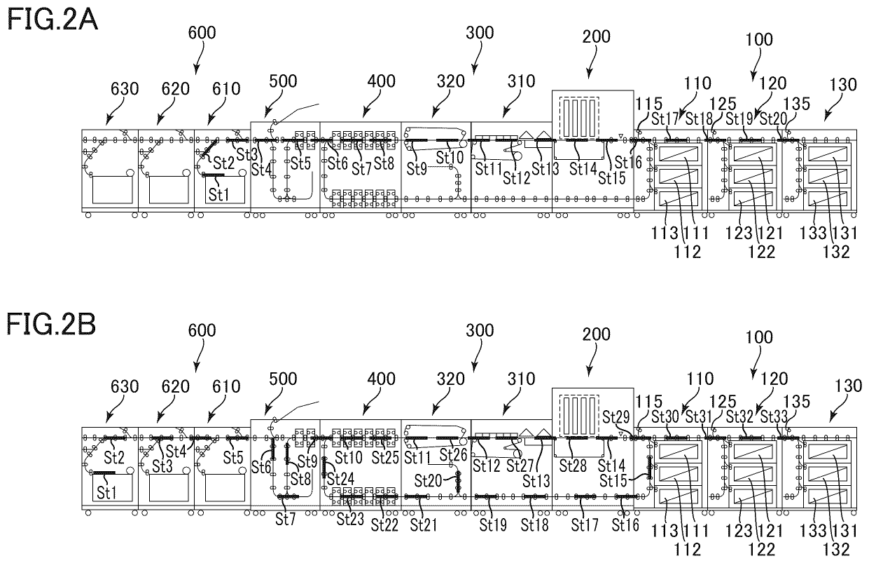

Next, conveyance of sheets in the image forming system 1 will be described with reference to FIGS. 2A and 2B. FIG. 2A is a schematic cross-sectional view illustrating positions of sheets in a case where a single-side printing job is performed in the image forming system of the first embodiment. FIG. 2B is a schematic cross-sectional view illustrating positions of sheets in a case where a double-side printing job is performed in the image forming system of the first embodiment.

As illustrated in FIG. 2A, in the execution of a print process of the single-side printing job, twenty sheets St1 to St20 are conveyed in the image forming system 1. Specifically, if a sheet is fed from the sheet feeding tray 131 of the sheet feeding apparatus 130 of the sheet feeding portion 100, the sheet is conveyed from the sheet feeding portion 100 to the print portion 200 for printing, and then conveyed sequentially through the units: the fixing portion 300, the cooling portion 400, and the reversing portion 500. The sheet conveyed from the reversing portion 500 is stacked on the sheet discharging stacker 611 of the sheet discharging apparatus 610 of the sheet discharging portion 600, as a printed sheet.

On the other hand, as illustrated in FIG. 2B, in the execution of a print process of the double-side printing job, thirty-three sheets St1 to St33 are conveyed in the image forming system 1. Specifically, if a sheet is fed from the sheet feeding tray 131 of the sheet feeding apparatus 130 of the sheet feeding portion 100, the sheet is conveyed, as in the single-side printing job, from the sheet feeding portion 100 to the print portion 200 for printing, and then conveyed sequentially through the units: the fixing portion 300, the cooling portion 400, and the reversing portion 500. A sheet with an image printed on the front side of the sheet is conveyed to a lower portion in the cooling portion 400, then conveyed sequentially through a lower portion of the fixing portion 300 and a lower portion of the print portion 200, and then returned to the sheet feeding apparatus 110 of the sheet feeding portion 100. In the lower portion of the fixing portion 300 through which the sheet is conveyed, the front side and the back side of the sheet are reversed to each other. The sheet having been returned to the sheet feeding apparatus 110 of the sheet feeding portion 100 is conveyed to the print portion 200 for performing printing on the back side (i.e., a second side) of the sheet, and in the print portion 200, the printing is performed on the back side of the sheet. After that, the sheet with images printed on both sides of the sheet is conveyed sequentially through the units: the fixing portion 300, the cooling portion 400, and the reversing portion 500, and is stacked on the sheet discharging stacker 631 of the sheet discharging apparatus 630 of the sheet discharging portion 600.

Note that in the present embodiment, the position of a sheet on which the control is performed is calculated, based on the time that has elapsed since the start of conveyance. That is, a time of a sheet calculated by a control portion of any one of units located upstream in the sheet conveyance direction is notified to a control portion of the unit, as a time at which the sheet will reach the entrance of the unit.

### Configuration of Sheet Feeding Apparatus

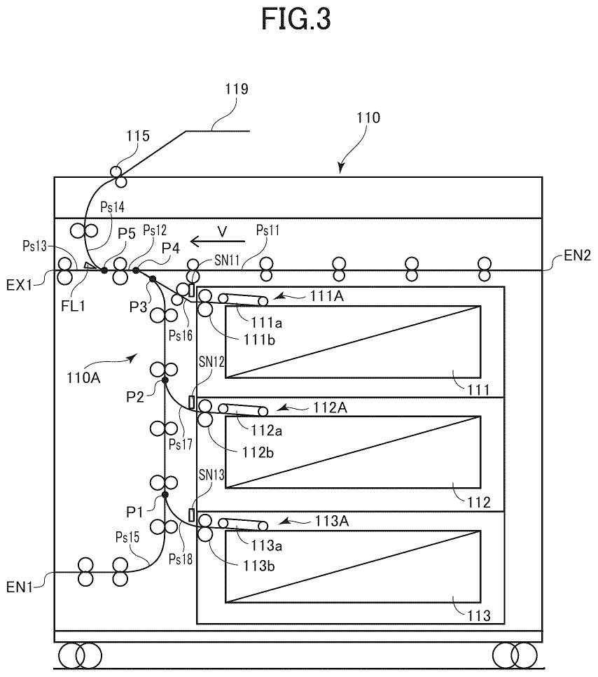

Next, a configuration of the sheet feeding apparatus 110 of the sheet feeding portion 100 will be described with reference to FIG. 3. FIG. 3 is a schematic cross-sectional view illustrating the sheet feeding apparatus of the first embodiment. Since the three sheet-feeding apparatus 110, sheet-feeding apparatus 120, and sheet-feeding apparatus 130 of the sheet feeding portion 100 of the present embodiment have the same configuration, the sheet feeding apparatus 110 of the three sheet-feeding apparatuses will be described, and the description of the sheet feeding apparatus 120 and the sheet feeding apparatus 130 will be omitted.

As illustrated in FIG. 3, the sheet feeding apparatus 110 includes the first to third sheet-feeding trays 111 to 113, which serve as a three-tier support portion. As described above, the first to third sheet-feeding trays 111 to 113 stack and store various types of printing (white) sheets used in the print process. Above each of the first sheet-feeding tray 111, the second sheet-feeding tray 112, and the third sheet-feeding tray 113, a corresponding one of sheet-feeding separation portion 111A, sheet-feeding separation portion 112A, and sheet-feeding separation portion 113A is disposed. Each of the sheet-feeding separation portions serves as a feeding portion that feeds sheets supported by a corresponding sheet feeding tray, one by one. The sheet-feeding separation portion 111A, the sheet-feeding separation portion 112A, and the sheet-feeding separation portion 113A respectively include sheet feeding belt 111a, sheet feeding belt 112a, and sheet feeding belt 113a. Each of the sheet feeding belts is driven by a motor (not illustrated), and thereby feeds the uppermost sheet floated by a fan (not illustrated) while sticking to the sheet. In addition, the sheet-feeding separation portion 111A, the sheet-feeding separation portion 112A, and the sheet-feeding separation portion 113A respectively include separation roller pair 111b, separation roller pair 112b, and separation roller pair 113b. Each of the separation roller pairs separates one sheet from the other if sheets are multi-fed by a corresponding one of the sheet feeding belt 111a, the sheet feeding belt 112a, and the sheet feeding belt 113a. Each of the separation roller pair 111b, the separation roller pair 112b, and the separation roller pair 113b is constituted by a common feed roller and a common retard roller, but may have any configuration. For example, another component, such as a separation pad, may be used in each of the separation roller pairs.

For detecting the multi-feeding of sheets, multi-feeding detection sensor SN11, multi-feeding detection sensor SN12, and multi-feeding detection sensor SN13 are disposed respectively downstream of the separation roller pair 111b, the separation roller pair 112b, and the separation roller pair 113b, in a sheet conveyance direction V. Each of the multi-feeding detection sensor SN11, the multi-feeding detection sensor SN12, and the multi-feeding detection sensor SN13 starts sensing at the leading edge of a fed sheet, and detects whether a plurality of sheets is fed simultaneously, and how much one sheet is shifted from another if the multi-feeding occurs.

Next, the conveyance path of sheets in the sheet feeding apparatus 110 will be described. The sheet feeding apparatus 110 includes a horizontal-path entrance EN2, serving as a taking-in port, that receives a sheet conveyed from an apparatus (i.e., the sheet feeding apparatus 120) disposed upstream in the sheet conveyance direction. In addition, the sheet feeding apparatus 110 includes a sheet discharging port EX1 that discharges a sheet to an apparatus (i.e., the print portion 200) disposed downstream in the sheet conveyance direction V. Furthermore, the sheet feeding apparatus 110 includes a double-side-printing-path entrance EN1 that receives a sheet conveyed from the above-described lower portion of the print portion 200 to the sheet feeding apparatus 110 for the double-side printing. In addition, the sheet feeding apparatus 110 includes a sheet discharging tray 119 that serves as a discharging support portion. As described in detail below, the sheet discharging tray 119 is a destination to which an error sheet is sent and discharged. That is, a sheet that becomes unacceptable or invalid due to the multi-feeding or the like is discharged to the sheet discharging tray 119, and stacked on and supported by the sheet discharging tray 119. Thus, the sheet feeding apparatus 110 includes the sheet discharging port 115 that can discharge the sheet to the sheet discharging tray 119. Similarly, the sheet feeding apparatus 120 and the sheet feeding apparatus 130 respectively include the above-described sheet discharging port 125 and the sheet discharging port 135 (see FIG. 1B), from which sheets can be discharged to the sheet discharging tray 129 and the sheet discharging tray 139.

The sheet feeding apparatus 110 includes a plurality of conveyance paths that causes the horizontal-path entrance EN2, the sheet discharging port EX1, the double-side-printing-path entrance EN1, the sheet discharging port 115, and the first to third sheet-feeding trays 111 to 113 to communicate with each other, and that guides a sheet. In addition, in the conveyance paths, a plurality of conveyance roller pairs is disposed for conveying sheets. The conveyance roller pairs constitute a conveyance portion 110A that conveys sheets.

Specifically, the sheet feeding apparatus 110 includes a first horizontal-conveyance path Ps11, a second horizontal-conveyance path Ps12 that serves as a first conveyance path, and a third horizontal-conveyance path Ps13 that serves as a second conveyance path. The first horizontal-conveyance path Ps11, the second horizontal-conveyance path Ps12, and the third horizontal-conveyance path Ps13 are horizontal paths that cause the horizontal-path entrance EN2 and the sheet discharging port EX1 to communicate with each other. In addition, the first horizontal-conveyance path Ps11, the second horizontal-conveyance path Ps12, and the third horizontal-conveyance path Ps13 are disposed, one adjacent to another on a straight line in a horizontal direction. In addition, the sheet feeding apparatus 110 includes an error sheet-discharging path Ps14 that serves as a third conveyance path. The error sheet-discharging path Ps14 is branched from an error-bin branch point P5 positioned between the second horizontal-conveyance path Ps12 and the third horizontal-conveyance path Ps13, and guides a sheet to the sheet discharging port 115. At the error-bin branch point P5, a switching portion FL1 is disposed. The switching portion FL1 can be switched between a first position and a second position by pivoting the switching portion FL1. In the first position, the switching portion FL1 guides a sheet conveyed in the second horizontal-conveyance path Ps12 by the conveyance portion 110A, to the third horizontal-conveyance path Ps13. In the second position, the switching portion FL1 guides a sheet conveyed in the second horizontal-conveyance path Ps12 by the conveyance portion 110A, to the error sheet-discharging path Ps14.

In addition, the sheet feeding apparatus 110 includes a duplex conveyance path Ps15. The duplex conveyance path Ps15 causes the double-side-printing-path entrance EN1 and a horizontal-path meeting point P4 positioned between the first horizontal-conveyance path Ps11 and the second horizontal-conveyance path Ps12, to communicate with each other, and guides a sheet. In addition, the sheet feeding apparatus 110 includes a tray conveyance path Ps18 that causes the third sheet-feeding tray 113 and a third-sheet-feeding-tray meeting point P1 to communicate with each other, and guides a sheet. In addition, the sheet feeding apparatus 110 includes a tray conveyance path Ps17 that causes the second sheet-feeding tray 112 and a second-sheet-feeding-tray meeting point P2 to communicate with each other, and guides a sheet. In addition, the sheet feeding apparatus 110 includes a tray conveyance path Ps16 that causes the first sheet-feeding tray 111 and a first-sheet-feeding-tray meeting point P3 to communicate with each other, and guides a sheet.

In the sheet feeding apparatus 110 configured as described above, a sheet fed from the first sheet-feeding tray 111 by the sheet-feeding separation portion 111A is conveyed to the sheet discharging port EX1 through the tray conveyance path Ps16, the duplex conveyance path Ps15, the second horizontal-conveyance path Ps12, and the third horizontal-conveyance path Ps13. Similarly, a sheet fed from the second sheet-feeding tray 112 by the sheet-feeding separation portion 112A is conveyed to the sheet discharging port EX1 through the tray conveyance path Ps17, the duplex conveyance path Ps15, the second horizontal-conveyance path Ps12, and the third horizontal-conveyance path Ps13. Similarly, a sheet fed from the third sheet-feeding tray 113 by the sheet-feeding separation portion 113A is conveyed to the sheet discharging port EX1 through the tray conveyance path Ps18, the duplex conveyance path Ps15, the second horizontal-conveyance path Ps12, and the third horizontal-conveyance path Ps13.

In addition, a sheet conveyed from the above-described sheet feeding apparatus 120 or the sheet feeding apparatus 130 (see FIG. 1B) is conveyed to the sheet discharging port EX1 through the horizontal-path entrance EN2, the first horizontal-conveyance path Ps11, the second horizontal-conveyance path Ps12, and the third horizontal-conveyance path Ps13. In addition, a sheet conveyed from the above-described print portion 200 (see FIG. 1B) is conveyed to the sheet discharging port EX1 through the double-side-printing-path entrance EN1, the duplex conveyance path Ps15, the second horizontal-conveyance path Ps12, and the third horizontal-conveyance path Ps13.

The above-described switching portion FL1 is driven by a switching-portion driving motor (not illustrated). When power is turned on or a print job is started, the switching portion FL1 is initialized so as to guide a sheet located in the second horizontal-conveyance path Ps12, to the third horizontal-conveyance path Ps13 (i.e., the sheet discharging port EX1). If the multi-feeding detection sensor SN11, the multi-feeding detection sensor SN12, or the multi-feeding detection sensor SN13, that serves as a multi-feeding detection portion detects the multi-feeding of sheets in the tray conveyance path Ps16, the tray conveyance path Ps17, or the tray conveyance path Ps18, the switching portion FL1 is switched from the first position to the second position, and the switching portion FL1 guides a sheet located in the second horizontal-conveyance path Ps12, to the error sheet-discharging path Ps14 (i.e., the sheet discharging port 115). The detailed description of the switch control of the switching portion FL1 will be made below.

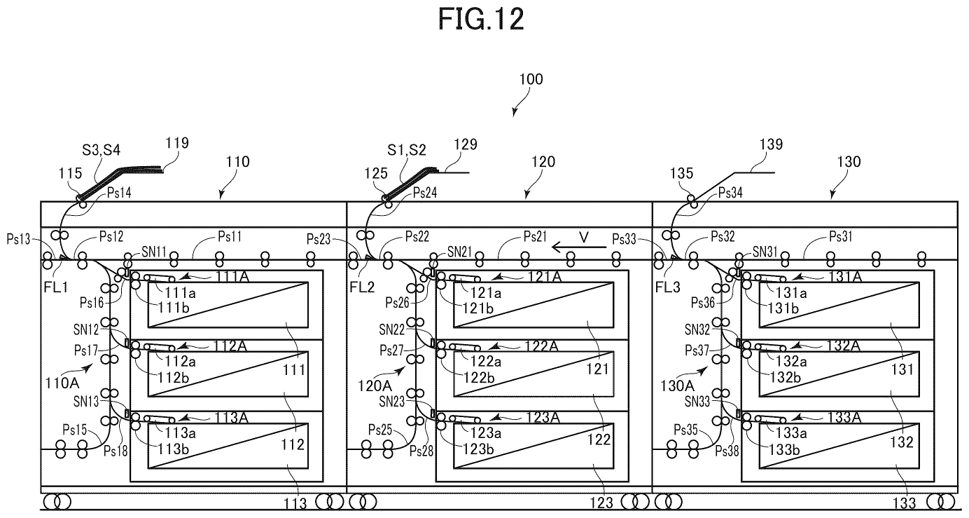

Note that the configuration of the above-described sheet feeding apparatus 110 is the same as the configuration of the sheet feeding apparatuses 120 and 130 disposed upstream of the sheet feeding apparatus 110 in the conveyance direction. In addition, although some components of the sheet feeding apparatus 110 are given reference symbols different from those of the sheet feeding apparatuses 120 and 130, the configuration of each component of the sheet feeding apparatus 110 is the same as the configuration of a corresponding component of the sheet feeding apparatuses 120 and 130. That is, as illustrated in FIG. 12, the sheet feeding apparatus 120 includes a first sheet-feeding tray 121, a second sheet-feeding tray 122, a third sheet-feeding tray 123, a sheet-feeding separation portion 121A that corresponds to the first sheet-feeding tray 121, a sheet-feeding separation portion 122A that corresponds to the second sheet-feeding tray 122, and a sheet-feeding separation portion 123A that corresponds to the third sheet-feeding tray 123. In addition, the sheet feeding apparatus 120 includes a first horizontal-conveyance path Ps21, a second horizontal-conveyance path Ps22 that serves as a first conveyance path or a fourth conveyance path, a third horizontal-conveyance path Ps23 that serves as a second conveyance path or a fifth conveyance path, and an error sheet-discharging path Ps24 that serves as a third conveyance path or a sixth conveyance path. In addition, the sheet feeding apparatus 120 includes a duplex conveyance path Ps25, a tray conveyance path Ps26, a tray conveyance path Ps27, and a tray conveyance path Ps28. In addition, the sheet feeding apparatus 120 includes multi-feeding detection sensors SN21, SN22, and SN23 that serve as multi-feeding detection portions; a switching portion FL2 that serves as a switching portion; and a sheet discharging tray 129 that serves as a discharging support portion.

Similarly, the sheet feeding apparatus 130 includes a first sheet-feeding tray 131, a second sheet-feeding tray 132, and a third sheet-feeding tray 133, a sheet-feeding separation portion 131A that corresponds to the first sheet-feeding tray 131, a sheet-feeding separation portion 132A that corresponds to the second sheet-feeding tray 132, and a sheet-feeding separation portion 133A that corresponds to the third sheet-feeding tray 133. In addition, the sheet feeding apparatus 130 includes a first horizontal-conveyance path Ps31, a second horizontal-conveyance path Ps32 that serves as a first conveyance path or a fourth conveyance path, a third horizontal-conveyance path Ps33 that serves as a second conveyance path or a fifth conveyance path, and an error sheet-discharging path Ps34 that serves as a third conveyance path or a sixth conveyance path. In addition, the sheet feeding apparatus 130 includes a duplex conveyance path Ps35, a tray conveyance path Ps36, a tray conveyance path Ps37, and a tray conveyance path Ps38. In addition, the sheet feeding apparatus 130 includes multi-feeding detection sensors SN31, SN32, and SN33 that serve as multi-feeding detection portions; a switching portion FL3; and a sheet discharging tray 139 that serves as a discharging support portion.

### Control Portion of Image Forming System

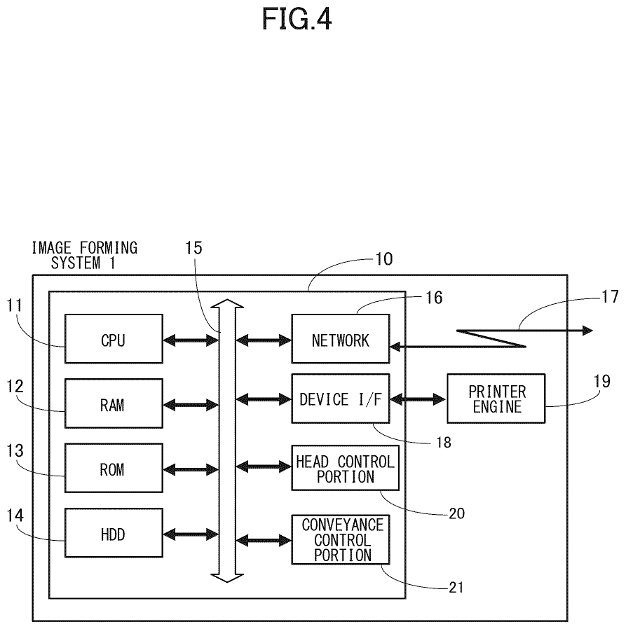

Next, a control portion 10 of the image forming system 1 will be described with reference to FIG. 4. FIG. 4 is a block diagram illustrating the control portion of the image forming system of the first embodiment.

As illustrated in FIG. 4, the image forming system 1 includes the control portion 10 that is a controller unit. The control portion 10 controls sending and receiving sensor signals and device information, and controls executing various processes of control. For example, a program in which processes are written is stored in a ROM 13 or an HDD 14, and installed in the image forming system 1. A CPU 11 of the control portion 10 reads the program stored in the ROM 13 or the HDD 14, from the ROM 13 or the HDD 14; stores the program in a RAM 12; and executes the program. In addition, the CPU 11 collectively controls the devices connected to a system bus 15. The RAM 12 functions as a main memory or a work memory of the CPU 11. The ROM 13 stores a boot program executed when power is turned on, and the HDD 14 stores an operating system and a control program of the system. The HDD 14 is also used for storing large

A Network 16 is connected to a local area network 17, and sends/receives data or device information to/from an external apparatus. The program may be installed in the ROM 13 or the HDD 14 via the Network 16. A device I/F 18 is an interface portion between the CPU 11 and a printer engine 19, and sends/receives signals for operating or referring to various motors, sensors, and the ink-jet head connected to the printer engine 19. The printer engine 19 is an ink-jet output device that conveys a printing sheet, depending on the control from the control portion 10, and that outputs an image sent from the print server 70, onto a printing sheet by controlling the ink-jet head 201 (see FIG. 1B). A head control portion 20 controls the ink-jet head 201 of the printer engine 19 via the device I/F 18, and performs the control, such as ink-ejection control for the image formation and head retraction control performed when an improper sheet is detected. A conveyance control portion 21 controls conveyance motors and sensors for feeding a printing sheet from the sheet feeding portion 100, conveying the sheet in synchronization with an ink ejection timing of the ink-jet head 201, and discharging the sheet to the sheet discharging portion 600.

Note that the description has been made for the case where the control portion 10 (i.e., a controller unit) is a single unit. However, a plurality of controller units may be used, separated from each other, and each of the sheet feeding portion 100, the print portion 200, the fixing portion 300, the cooling portion 400, the reversing portion 500, and the sheet discharging portion 600 may include a corresponding one of the controller units. In this case, a specific controller unit collectively controls the other controller units.

### Control Portion of Sheet Feeding Apparatus

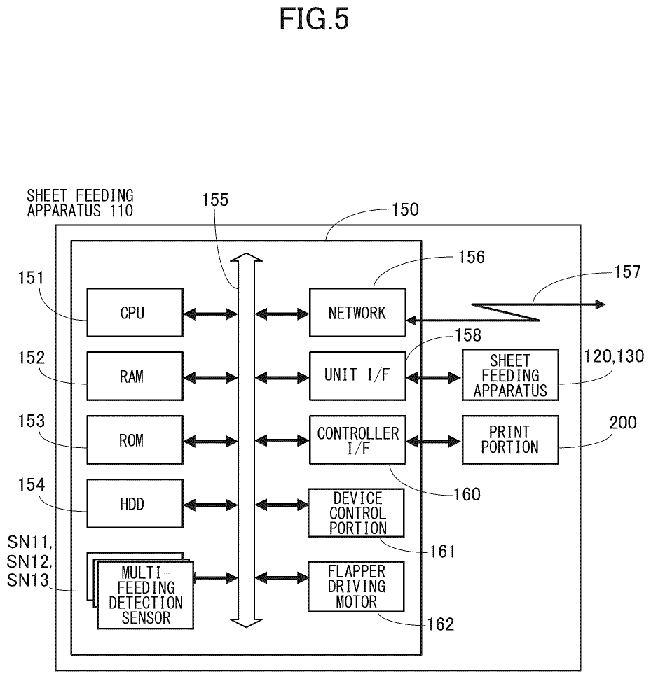

Next, a configuration of a control portion 150 of the sheet feeding apparatus 110 will be described with reference to FIG. 5. FIG. 5 is a block diagram illustrating the control portion of the sheet feeding apparatus of the first embodiment. The description will be made for a case where the sheet feeding apparatus 110, the sheet feeding apparatus 120, and the sheet feeding apparatus 130 of the sheet feeding portion 100 include corresponding control portions (i.e., controller units) separated from each other, and where the control portion 150 of the sheet feeding apparatus 110 is one of the control portions. That is, each of the sheet feeding apparatus 120 and the sheet feeding apparatus 130 includes a control portion identical to the control portion 150. In this configuration, even in a case where the sheet feeding portion 100 includes three apparatuses (units) identical to each other, connected in series with each other, and serving as sheet feeding units (that is, three sheet feeding apparatuses identical to each other and connected in series with each other), the system can be built easily.

As illustrated in FIG. 5, the sheet feeding apparatus 110 includes the control portion 150 that is a controller unit. The control portion 150 controls sending and receiving sensor signals and device information, and controls executing various processes of control. For example, a program in which processes are written is stored in a ROM 153 or an HDD 154, and installed in the sheet feeding apparatus 110. A CPU 151 reads the program stored in the ROM 153 or the HDD 154, from the ROM153 or the HDD154; stores the program in a RAM 152; and executes the program. In addition, the CPU 151 collectively controls the devices connected to a system bus 155. The RAM 152 functions as a main memory or a work memory of the CPU 151. The ROM 153 stores a boot program executed when power is turned on, and the HDD 154 stores an operating system and a control program of the apparatus. The HDD 154 is also used for storing large data temporarily or for a long time.

A Network 156 is connected to a local area network 157, and sends/receives data or device information to/from an external apparatus. The program may be installed in the ROM 153 or the HDD 154 via the Network 156. A unit I/F 158 is an interface portion between the CPU 151 and an apparatus disposed adjacent to the sheet feeding apparatus 110. In the present embodiment, the unit I/F 158 is connected to the sheet feeding apparatus 120 (i.e., the control portion of the sheet feeding apparatus 120) connected to the sheet feeding apparatus 110. A controller I/F 160 is an interface portion between the controller and the print portion 200, and is connected with the print portion 200 of the image forming system 1 (i.e., the control portion of the print portion 200). A device control portion 161 controls sheet feeding fans for feeding printing sheets from the first to third sheet-feeding trays 111 to 113, and controls conveyance motors and sensors for conveying sheets to the downstream apparatus or the sheet discharging tray 119 (see FIG. 3). As described above, each of the multi-feeding detection sensor SN11, the multi-feeding detection sensor SN12, and the multi-feeding detection sensor SN13 detects the multi-feeding of sheets fed from a corresponding one of the sheet-feeding separation portion 111A, the sheet-feeding separation portion 112A, and the sheet-feeding separation portion 113A. A switching-portion driving motor 162 (FLAPPER DRIVING MOTOR) drives the switching portion FL1 for switching the above-described position of the switching portion FL1.

### Control Functions of Sheet Feeding Apparatus

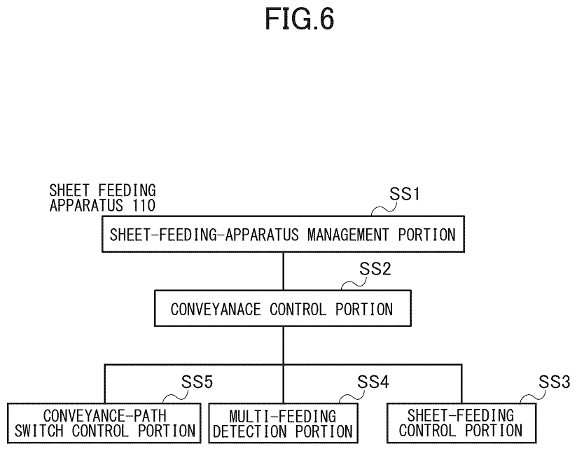

Next, control functions achieved by the control portion 150 of the above-described sheet feeding apparatus 110 performing various types of control (processes) will be described with reference to FIG. 6. FIG. 6 is a block diagram illustrating the control functions of the sheet feeding apparatus of the first embodiment. Note that the control portion of each of the sheet feeding apparatus 120 and the sheet feeding apparatus 130 also has the same control functions as those illustrated in FIG. 6. Each component illustrated in FIG. 6 and serving as a software module functions such that the component is stored in the HDD 154, as a program, then loaded into the RAM 152, and then executed by the CPU 151.

A sheet-feeding-apparatus management portion SS1 sends/receives print-job information and instructions or responses to/from the print portion 200 via the controller I/F 160, and collectively controls the components of the sheet feeding apparatus 110. Upon receiving a request for conveying a sheet (i.e., a request for feeding a sheet or a request for conveying a sheet in the double-side printing), the sheet-feeding-apparatus management portion SS1 sends an instruction for conveying a sheet, to a conveyance control portion SS2. The conveyance control portion SS2 sends an instruction to a sheet-feeding control portion SS3, a multi-feeding detection portion SS4, or a conveyance-path switch control portion SS5 in accordance with a conveyance route of the above-described conveyance paths. That is, while sending an instruction to each of the control portions, the conveyance control portion SS2 performs the control for conveying a sheet to be fed or a sheet conveyed from one adjacent apparatus, to another adjacent apparatus (i.e., the print portion 200) disposed downstream in the conveyance direction V, or to the sheet discharging port 115 in accordance with a sheet conveyance time.

The sheet-feeding control portion SS3 controls the sheet-feeding separation portion 111A, the sheet-feeding separation portion 112A, and the sheet-feeding separation portion 113A; and feeds sheets, one by one, stacked on each of the sheet feeding tray 111, the sheet feeding tray 112, and the sheet feeding tray 113. The multi-feeding detection portion SS4 causes the multi-feeding detection sensor SN11, the multi-feeding detection sensor SN12, and the multi-feeding detection sensor SN13 to sense sheets fed from the corresponding sheet feeding tray 111, the corresponding sheet feeding tray 112, and the corresponding sheet feeding tray 113. That is, each of the multi-feeding detection sensor SN11, the multi-feeding detection sensor SN12, and the multi-feeding detection sensor SN13 detects whether sheets are multi-fed, and how much a plurality of sheets that overlap with each other is shifted from each other in the conveyance in the conveyance direction V if the sheets are multi-fed. The conveyance-path switch control portion SS5 switches the destination of sheets to the sheet discharging port 115 by switching the switching portion FL1 in a case where the multi-feeding of sheets has been detected or the sheets that are being conveyed have become unacceptable due to another error. In this case, the sheets are determined as error sheets. The switching portion FL1 is switched by driving the switching-portion driving motor 162.

### Conveyance-Route Management Table

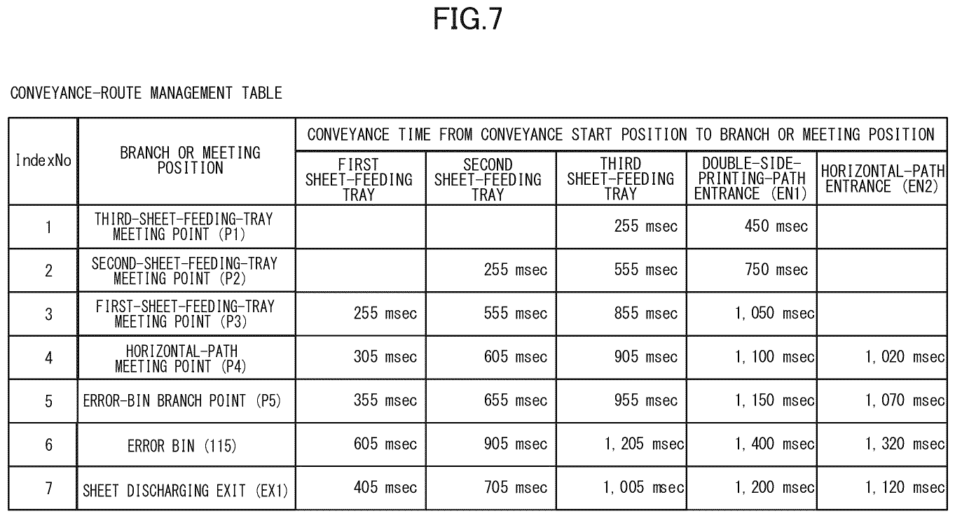

Next, a conveyance-route management table included in the control portion 150 of the sheet feeding apparatus 110 will be described with reference to FIG. 7. FIG. 7 is a table illustrating the conveyance-route management table of the sheet feeding apparatus of the first embodiment.

In the conveyance of a sheet, there is a case where the sheet is conveyed from the conveyance start position of each component to the sheet discharging port (an error bin) past a branch position and a meeting position. For managing the time at which the sheet passes the branch position and the meeting position, in the conveyance-route management table, each position and a corresponding passage time are recorded, associated with each other, as illustrated in FIG. 7. Note that in the present embodiment, the position of a sheet which is conveyed and on which the control is performed is calculated, based on the time that has elapsed since the start of conveyance.

The conveyance-route management table contains information on the Index-No, information on the branch or meeting position, and information on the conveyance time from a conveyance start position to a branch or meeting position. The Index-No is an identifier for uniquely identifying the conveyance route information. The branch or meeting position is the name of the branch position (P5) and the meeting positions (P1, P2, P3, and P4) (see FIG. 3). The conveyance time from a conveyance start position to a branch or meeting position is a conveyance time taken from a conveyance start position (0 mm) that is the first sheet-feeding tray 111, the second sheet-feeding tray 112, the third sheet-feeding tray 113, the double-side-printing-path entrance EN1, or the horizontal-path entrance EN2. That is, the conveyance time from a conveyance start position to a branch or meeting position is a time taken for a sheet to move from the conveyance start position to the branch or meeting position, which are positioned on the conveyance path for discharging the sheet to the target sheet-discharging destination. That is, the conveyance-route management table contains information on the time at which a sheet conveyed from each conveyance start position reaches a branch or meeting position. Thus, the time at which a sheet passes a point on the conveyance path can be calculated from the information contained in the conveyance-route management table, and from the time which is notified from the control portion 10 of the print portion 200 and at which the sheet is located in the conveyance start position.

### Sheet Information

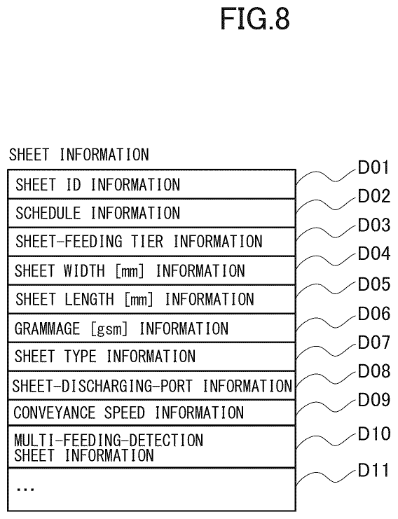

Next, sheet information used by the sheet feeding apparatus 110 will be described. FIG. 8 is a diagram illustrating a list of the sheet information. Note that the sheet information is stored, for example, in the HDD 14 of the control portion 10 of the image forming system 1. The sheet information, together with a print instruction notified from the print portion 200, is also notified to the control portion 150 of the sheet feeding apparatus 110. The sheet information notified is stored in the RAM 12 of the control portion 10 of the image forming system 1, and in the RAM 152 of the control portion 150 of the sheet feeding apparatus 110. The sheet information is used for various types of control. That is, the sheet feeding apparatus 110 performs conveyance control, based on the sheet information. Note that the sheet information is also notified to and stored in the sheet feeding apparatuses 120 and 130. In the present embodiment, the sheet feeding apparatus 110 will be described as one example.

As illustrated in FIG. 8, in the sheet information, sheet ID information D01, schedule information D02, sheet-feeding tier information D03, sheet width information D04, sheet length information D05, grammage information D06, and sheet type information D07 are listed and contained. In addition, in the sheet information, sheet-discharging-port information D08, conveyance speed information D09, multi-feeding-detection sheet information D10, and other information D11 are listed and stored. For example, a sheet feeding tray for feeding sheets is specified in the sheet-feeding tier information D03. In addition, as an example, the control portion 150 of the sheet feeding apparatus 110 sets a flag of ON in the multi-feeding-detection sheet information D10 if the control portion 150 detects the multi-feeding. The flag of ON or OFF of the multi-feeding-detection sheet information D10 is notified to the sheet feeding apparatuses 110, 120, and 130 such that the flag of one sheet feeding apparatus is notified to the other sheet feeding apparatuses. For example, the information that the multi-feeding has occurred in a sheet feeding apparatus disposed upstream in the conveyance direction can be shared by the other sheet feeding apparatuses because the information on the flag is shared by the sheet feeding apparatuses.

### Control of Sheet Feeding Apparatus of First Embodiment

Hereinafter, the control of the sheet feeding apparatus of the present embodiment will be described in detail with reference to a flowchart. Note that the control of the sheet feeding apparatus described below is performed by the CPU 151 of the control portion 150 of each of the sheet feeding apparatuses 110, 120, and 130. For example, in a case where the sheet feeding is started from any one of the first to third sheet-feeding trays 121 to 123 of the sheet feeding apparatus 120, the sheet feeding apparatus 120 serves as an upstream sheet-feeding apparatus disposed upstream in the conveyance direction, and the sheet feeding apparatus 110 serves as a downstream sheet-feeding apparatus that receives sheets fed from the sheet feeding apparatus 120. In addition, in a case where the sheet feeding is started from any one of the first to third sheet-feeding trays 131 to 133 of the sheet feeding apparatus 130, the sheet feeding apparatus 130 serves as an upstream sheet-feeding apparatus disposed upstream in the conveyance direction, and the sheet feeding apparatus 120 serves as a downstream sheet-feeding apparatus that receives sheets fed from the sheet feeding apparatus 130. Thus, the control portion 150 of each of the sheet feeding apparatuses 110, 120, and 130 performs the conveyance control so as to be able to achieve both functions of an upstream sheet-feeding apparatus and a downstream sheet-feeding apparatus disposed in the conveyance direction.

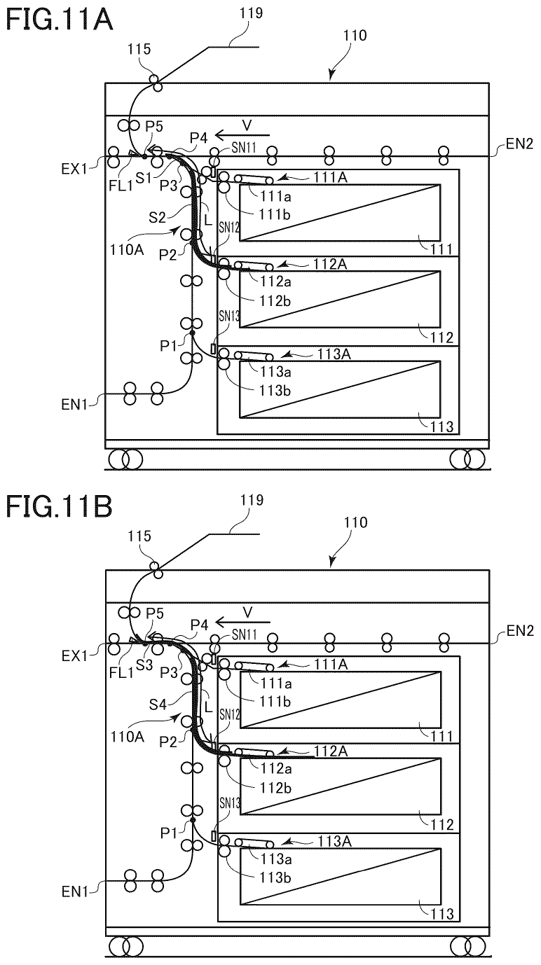

Note that in the following description, the first sheet that a sheet feeding tray starts to feed is referred to as a sheet S1 or S3 that serves as a first sheet, and the second sheet following the first sheet and multi-fed is referred to as a sheet S2 or S4 that serves as a second sheet. As described in detail below, the sheets S1 and S2 are sheets whose length in the conveyance direction is shorter than a distance L from the multi-feeding detection sensor (or the first to third sheet-feeding trays) to the switching portion FL1 (or the error-bin branch point P5) (see FIG. 11A). In contrast, the sheets S3 and S4 are sheets whose length in the conveyance direction is longer than (or equal to) the distance L from the multi-feeding detection sensor (or the first to third sheet-feeding trays) to the switching portion FL1 (or the error-bin branch point P5) (see FIG. 11B).

### Conveyance Control

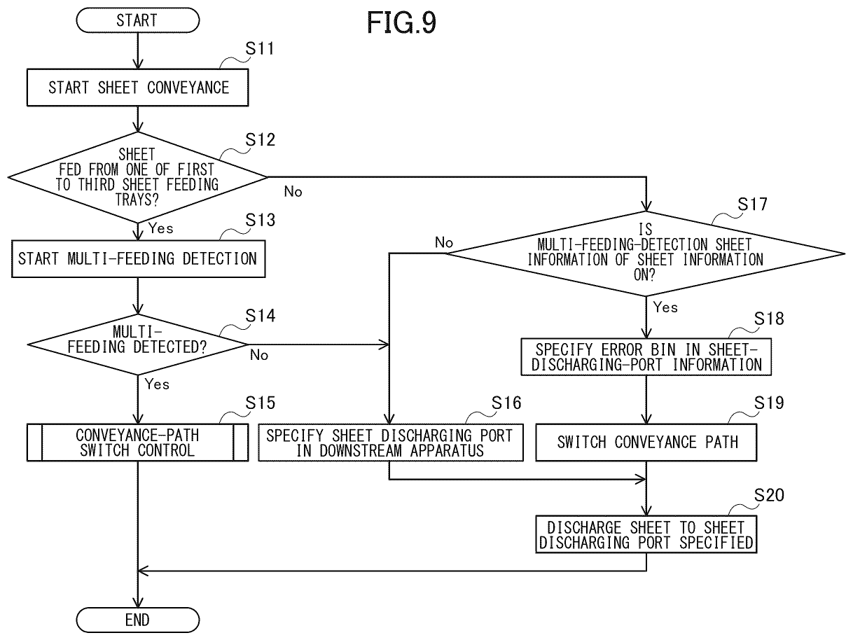

First, the conveyance control of the sheet feeding apparatus of the first embodiment will be described with reference to FIG. 9. FIG. 9 is a flowchart illustrating the conveyance control of the sheet feeding apparatus of the first embodiment. For example, the control portion 150 of any one of the sheet feeding apparatuses 110, 120, and 130 receives a print instruction from the control portion 10 of the image forming system 1 (or the control portion of the print portion 200). Then the sheet-feeding-apparatus management portion SS1 of a sheet feeding apparatus that will feed sheets starts to feed the sheet S1 (or the sheet S3) stacked on any one of the first to third sheet-feeding trays. If the start of the sheet feeding has succeeded, the control is started.

Then the CPU 151 of an upstream sheet-feeding apparatus that starts to feed the sheet S1 (or the sheet S3), or the CPU 151 of a downstream sheet-feeding apparatus that receives the sheet S3 starts the conveyance operation of sheets (S11). Then the CPU 151 determines whether the sheet that is being conveyed was fed from any one of the first to third sheet feeding trays of the sheet feeding apparatus that includes the CPU 151 (S12). For determining whether the sheet was fed from the sheet feeding apparatus that includes the CPU 151, the CPU 151 refers to the sheet-feeding tier information D03 contained in the sheet information illustrated in FIG. 8. If any one of the first to third sheet feeding trays of the sheet feeding apparatus that includes the CPU 151 is specified in the sheet-feeding tier information D03 (S12: Yes), then the CPU 151 proceeds to Step S13 and performs the conveyance control, as the upstream sheet-feeding apparatus. On the other hand, in a case where none of the first to third sheet feeding trays of the sheet feeding apparatus that includes the CPU 151 are specified in the sheet-feeding tier information D03 (S12: No), the sheet feeding apparatus has received the sheet S3 (or the sheets S3 and S4 in the multi-feeding) from an upstream sheet-feeding apparatus. In this case, the CPU 151 proceeds to Step S17 and performs the conveyance control, as the downstream sheet-feeding apparatus.

If the CPU 151 proceeds to Step S13, then the CPU 151 starts the multi-feeding detection at a timing at which the sheet S1 (or the sheet S3), the feeding of which has been started, reaches a predetermined position. The CPU 151 performs the multi-feeding detection by using a multi-feeding detection sensor that corresponds to the sheet-feeding tier information D03 on the sheet S1 (or the sheet S3). Then the CPU 151 determines whether the multi-feeding detection sensor, which has started the multi-feeding detection, has detected the multi-feeding (S14). The multi-feeding detection sensor performs the detection in a period of time from when the multi-feeding detection sensor detects the leading edge of the sheet S1 (or the sheet S3), until when the trailing edge of the sheet S1 (or the sheet S3) passes through the multi-feeding detection sensor. If the multi-feeding detection sensor has detected the multi-feeding of the sheet S2 (or the sheet S4) that overlaps with the sheet S1 (or the sheet S3) (S14: Yes), then the CPU 151 proceeds to Step S15. If the multi-feeding detection sensor has not detected the multi-feeding of the sheet S1 (or the sheet S3) (Step S14: No), then the CPU 151 proceeds to Step S16.

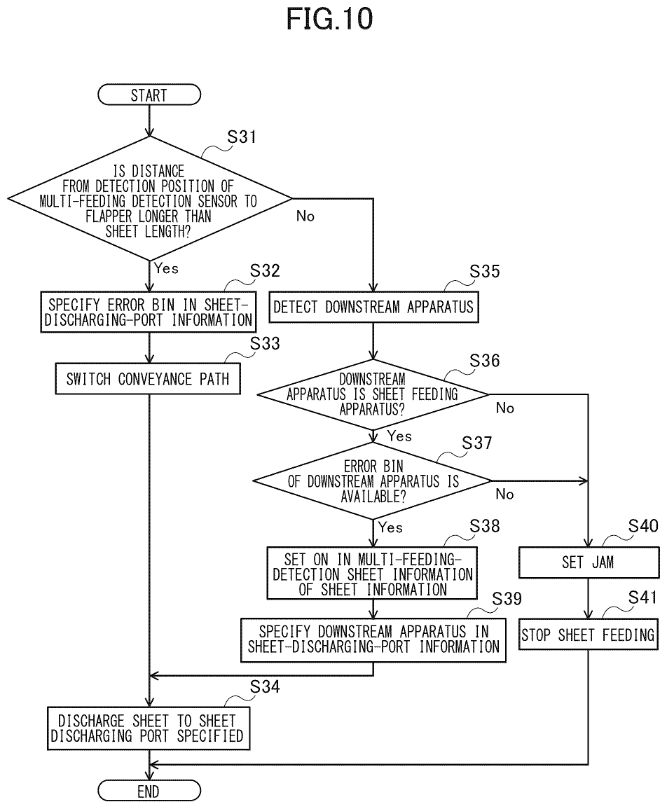

If the CPU 151 proceeds to Step S15, then the CPU 151 performs conveyance-path switch control (described in detail below) on the sheets S1 and S2 (or the sheets S3 and S4) on which the multi-feeding has been detected. The conveyance-path switch control will be described in detail with reference to FIG. 10.

On the other hand, if the CPU 151 proceeds to Step S16, then the CPU 151 specifies the sheet discharging port EX1 in the sheet-discharging-port information D08 of the sheet information, as the sheet discharging port for the sheet S1 (or the sheet S3) on which the multi-feeding has not been detected. Then the CPU 151 conveys the sheet S1 while keeping the position of the switching portion FL1 at a first position (i.e., an initial position) for discharging the sheet S1 (or the sheet S3) from the sheet discharging port EX1 specified in the sheet-feeding-port information D08 (S20). In this manner, the sheet S1 (or the sheet S3) on which the multi-feeding has not been detected is discharged from the sheet discharging port EX1 to a downstream apparatus (i.e., the print portion 200, the sheet feeding apparatus 110, or the sheet feeding apparatus 120). With this operation, the CPU 151 ends the conveyance control performed on the sheet S1 (or the sheet S3).

In the above-described Step S12, if the CPU 151 determines that the sheet feeding tray that started to feed a sheet that is being conveyed is not one of the first to third sheet feeding trays of the sheet feeding apparatus that includes the CPU 151 (S12: No), then the CPU 151 proceeds to Step S17. In this case, the CPU 151 determines that the sheet S3 has been conveyed from an upstream sheet-feeding apparatus, and determines whether the multi-feeding-detection sheet information D10 for the sheet S3 received from the horizontal-path entrance EN2 is ON (S17). If the multi-feeding-detection sheet information D10 is OFF (S17: No), then the CPU 151 determines that the sheet S3 conveyed from the upstream sheet-feeding apparatus is a normal sheet that is not multi-fed, and proceeds to Step S16.

In a case where the CPU 151 proceeds to Step S16 in this manner, the CPU 151 also specifies the sheet discharging port EX1 in the sheet-discharging-port information D08 of the sheet information, as the sheet discharging port for the sheet S3 on which the multi-feeding has not been detected. Then the CPU 151 conveys the sheet S3 while keeping the position of the switching portion FL1 at the first position (i.e., an initial position) for discharging the sheet S3 from the sheet discharging port EX1 specified in the sheet-feeding-port information D08 (S20). In this manner, the sheet S3 on which the multi-feeding has not been detected is discharged from the sheet discharging port EX1 to a downstream apparatus (i.e., the print portion 200 or the sheet feeding apparatus 110). With this operation, the CPU 151 ends the conveyance control performed on the sheet S3.

On the other hand, if the multi-feeding-detection sheet information D10 for the sheet S3 received from the horizontal-path entrance EN2 is ON in the above-described Step S17 (S17: Yes), then the CPU 151 determines that the sheet S3 received is a multi-fed sheet conveyed (multi-fed) together with the sheet S4, and specifies the sheet discharging port 115 in the sheet-discharging-port information D08. Then the CPU 151 switches the switching portion FL1 at a timing earlier by a predetermined time than the time when the leading edge of the sheet S3 reaches the error-bin branch point (P5). That is, the CPU 151 switches the conveyance path (S19). Then the CPU 151 discharges the sheets S3 and S4 from the sheet discharging port 115 to the sheet discharging tray 119 by driving conveyance rollers of the conveyance path extending to the sheet discharging port 115 specified in the sheet-discharging-port information D08. With this operation, the CPU 151 ends the conveyance control performed on the sheets S3 and S4.

### Conveyance-Path Switch Control

Next, the conveyance-path switch control of the first embodiment will be described with reference to FIGS. 10, 11A, 11B, and 12. FIG. 10 is a flowchart illustrating the conveyance-path switch control of the sheet feeding apparatus of the first embodiment. FIG. 11A is a diagram illustrating a case where the length of a sheet S1 multi-fed in the sheet feeding apparatus 110 is shorter than a distance L between the multi-feeding detection sensor SN12 and the switching portion FL1. FIG. 11B is a diagram illustrating a case where the length of a sheet S3 multi-fed in the sheet feeding apparatus 110 is longer than the distance L between the multi-feeding detection sensor SN12 and the switching portion FL1. FIG. 12 is a schematic cross-sectional view illustrating a case where multi-fed sheets are discharged to a sheet discharging tray in a feeding portion of the image forming system of the first embodiment.

The conveyance-path switch control is control for changing the destination of a sheet that is being conveyed, by switching the position of the switching portion FL2 of the sheet feeding apparatus 120 disposed upstream of the sheet feeding apparatus 110. In the first embodiment, the description will be made for the control that switches the conveyance path, based on the sheet size (i.e., the length of a sheet in the conveyance direction) and the distance L from the detection position of the multi-feeding detection sensor SN22 to the switching portion FL2. Note that the distance from the detection position of the multi-feeding detection sensor SN22 disposed for the second sheet-feeding tray 122, to the switching portion FL2 is longer than the distance from the detection position of the multi-feeding detection sensor SN21 disposed for the first sheet-feeding tray 121, to the switching portion FL2. Similarly, the distance from the detection position of the multi-feeding detection sensor SN23 disposed for the third sheet-feeding tray 123, to the switching portion FL2 is longer than the distance from the detection position of the multi-feeding detection sensor SN22 disposed for the second sheet-feeding tray 122, to the switching portion FL2. The following description will be made for a case where the sheet S1 or S3 is fed from the second sheet-feeding tray 122. However, the present disclosure is not limited to this.

If the CPU 151 proceeds to Step S15 in the above-described conveyance-path switch control (see FIG. 9), then the CPU 151 starts the conveyance-path switch control of the first embodiment. Then the CPU 151 determines whether to switch the conveyance path for the sheet S1 or S3 on which the multi-feeding has been detected. That is, as illustrated in FIGS. 11A and 11B, the CPU 151 compares the distance L from the detection position of the multi-feeding detection sensor SN22 to the switching portion FL2, and the length of the sheet S1 or S3 (S31). The CPU 151 refers to a value stored in the ROM 153, for obtaining the distance L from the detection position of the multi-feeding detection sensor SN22 to the switching portion FL2; and refers to the sheet length information D05 (see FIG. 8) of the sheet information for obtaining the length of the sheet S1 or S3.

If the distance from the detection position of the multi-feeding detection sensor SN22 to the switching portion FL2 is longer than the length of the sheet S1 as illustrated in FIG. 11A (S31: Yes), then the CPU 151 determines that the leading edge of the sheet S1 is located upstream of the switching portion FL2 (i.e., the error-bin branch point P5) in the conveyance direction when the multi-feeding is detected in any position of the sheets S1 and S2. That is, the CPU 151 determines that the switching of the switching portion FL2 can be completed by the time when the leading edge of the sheet S1 reaches the switching portion FL2.

Thus, the CPU 151 proceeds to Step S32, and specifies the error bin (i.e., the sheet discharging port 125) in the sheet-discharging-port information D08. In this manner, the CPU 151 switches the switching portion FL2 from the first position that is an initial position, to the second position at a timing earlier by a predetermined time than the time when the leading edge of the sheet S1 reaches the error-bin branch point (P5). That is, the CPU 151 switches the conveyance path (S33). In addition, the CPU 151 drives conveyance rollers of the error sheet-discharging path Ps24 extending to the sheet discharging port 125 (i.e., the sheet discharging tray 129) specified in the sheet-discharging-port information D08 (S34). In this manner, the CPU 151 discharges the sheets S1 and S2 to the sheet discharging tray 129 of the sheet feeding apparatus 120, as illustrated in FIG. 12. With this operation, the CPU 151 ends the conveyance-path switch control.

On the other hand, as illustrated in FIG. 11B, if the distance L from the detection position of the multi-feeding detection sensor SN22 to the switching portion FL2 is equal to the length of the sheet S3, or the length of the sheet S3 is longer than the distance L (S31: No), the leading edge of the sheet S3 may have passed through the switching portion FL2, depending on the position where the multi-feeding is detected. In this case, the CPU 151 determines that the switching of the switching portion FL2 cannot be completed by the time when the leading edge of the sheet S3 reaches the switching portion FL2. Thus, the CPU 151 proceeds to Step S35.

If the CPU 151 proceeds to Step S35, then the CPU 151 checks an apparatus disposed downstream in the conveyance direction and connected to the sheet feeding apparatus 120. The CPU 151 communicates with the sheet feeding apparatuses 110 and 130 adjacent to the sheet feeding apparatus 120, via the unit I/F 158 (see FIG. 5). Thus, in this process, the CPU 151 obtains connection detection information and a sheet-feeding-apparatus ID assigned to a corresponding sheet feeding apparatus. Then the CPU 151 determines based on the connection detection information obtained in Step S35 whether the adjacent sheet feeding apparatus 110, disposed downstream in the conveyance direction, is connected to the sheet feeding apparatus 120 (S36). Specifically, if the CPU 151 can obtain the connection detection information, and the sheet-feeding-apparatus ID is smaller than the sheet-feeding-apparatus ID of the sheet feeding apparatus that includes the CPU 151, then the CPU 151 determines that the sheet feeding apparatus 110, disposed downstream, is connected to the sheet feeding apparatus 120 (S36: Yes) and proceeds to Step S37. On the other hand, if the CPU 151 cannot obtain the connection detection information, or the sheet-feeding-apparatus ID is larger than the sheet-feeding-apparatus ID of the sheet feeding apparatus that includes the CPU 151 even though the CPU 151 can obtain the connection detection information, then the CPU 151 determines that the print portion 200, disposed downstream, is connected to the sheet feeding apparatus 120, and that the sheet feeding apparatus 110 is not connected to the sheet feeding apparatus 120 (S36: No). In this case, the CPU 151 proceeds to Step S40.

If the CPU 151 proceeds to Step S37, then the CPU 151 determines whether the error bin (i.e., the error sheet-discharging path Ps14 and the sheet discharging tray 119) of the downstream sheet feeding apparatus 110, which is adjacent to the sheet feeding apparatus 120, is available (S37). Specifically, the CPU 151 obtains, via the unit I/F 158, the state of the error bin of the downstream sheet feeding apparatus 110, which is adjacent to the sheet feeding apparatus 120; and proceeds to Step S38 if the CPU 151 determines that the error bin of the downstream sheet feeding apparatus 110 is available (S37: Yes). On the other hand, if the CPU 151 determines that the error bin of the downstream sheet feeding apparatus 110 is unavailable (S37: No), then the CPU 151 proceeds to Step S40. The error bin of the downstream sheet feeding apparatus 110 is unavailable, for example, in a case where the error bin is in a state where sheets are fully stacked on the sheet discharging tray 119, or where sheets cannot be fed due to the occurrence of jam in the error sheet-discharging path Ps14.

If the CPU 151 proceeds to Step S38, then the CPU 151 sets ON in the multi-feeding-detection sheet information D10 of the sheet information, specifies the sheet discharging port EX1 in the sheet-discharging-port information D08 of the sheet information (S39), and proceeds to Step S34. In this case, the CPU 151 notifies the downstream sheet feeding apparatus 110, adjacent to the sheet feeding apparatus 120, of the multi-feeding-detection sheet information D10 via the unit I/F 158. Note that the CPU 151 may notifies the downstream sheet feeding apparatus 110 of the sheet information itself, or of only the sheet ID information D01 and the multi-feeding-detection sheet information D10 of the sheet information. Then the CPU 151 drives conveyance rollers of the conveyance path extending to the sheet discharging port EX1 of the sheet feeding apparatus 120 specified in the sheet-discharging-port information D08 (S34). In this manner, the CPU 151 discharges the sheets S3 and S4 from the sheet feeding apparatus 120 to the sheet feeding apparatus 110, and to the sheet discharging tray 119 of the sheet feeding apparatus 110, as illustrated in FIG. 12. With this operation, the CPU 151 ends the conveyance-path switch control.

In addition, as described above, if the downstream apparatus is not the sheet feeding apparatus 110 but the print portion 200 (S36: No), or the error bin is unavailable even though the downstream apparatus is the sheet feeding apparatus 110 (S37: No), then the CPU 151 proceeds to Step S40. If the CPU 151 proceeds to Step S40, then the CPU 151 sets jam information for the sheets S3 and S4 that are being conveyed. Then the CPU 151 stops the driving of the conveyance rollers of the sheet feeding apparatus 120, that is, stops the feeding of sheets performed by the sheet feeding apparatus 120 (S41). With this operation, the CPU 151 ends the conveyance-path switch control.

### Summary of First Embodiment

As described above, in the sheet feeding apparatus 120 of the first embodiment, in a case where the multi-feeding is detected by the multi-feeding detection sensor SN21, SN22, or SN23, the CPU 151 determines whether the switching of the switching portion FL2 can be completed by the time when the leading edge of the sheet S1 reaches the switching portion FL2. In addition, if the CPU 151 determines that the switching of the switching portion FL2 can be completed by the time when the leading edge of the sheet S1 reaches the switching portion FL2, the CPU 151 switches the switching portion FL2 to the second position. With this operation, the CPU 151 guides the multi-fed sheets S1 and S2 to the sheet discharging tray 129. If the CPU 151 determines that the switching of the switching portion FL2 cannot be completed by the time when the leading edge of the sheet S3 reaches the switching portion FL2, the CPU 151 does not switch the switching portion FL2, and guides the sheets S3 and S4 to the third horizontal-conveyance path Ps23. With this operation, in a case where the multi-fed sheets S3 and S4 cannot be discharged to the sheet discharging tray 129, the CPU 151 discharges the sheets S3 and S4 to the downstream sheet feeding apparatus 110. If the multi-fed sheets S3 and S4 are conveyed in the second horizontal-conveyance path Ps12, the sheet feeding apparatus 110 switches the switching portion FL1 to the second position, and guides the sheets S3 and S4 to the sheet discharging tray 119. With this operation, the sheet feeding apparatus 110 can guide the multi-fed sheets S3 and S4 to the sheet discharging tray 119. Thus, the occurrence of jam can be prevented even in a case where the multi-feeding is detected, and where the switching of the switching portion FL2 cannot be completed by the time when the leading edge of the sheet S3 reaches the switching portion FL2.

In addition, in a case where the length of a sheet in the conveyance direction is shorter than the distance from the detection position of the multi-feeding detection sensor to the switching portion, the CPU 151 determines that the switching of the switching portion can be completed by the time when the leading edge of the sheet reaches the switching portion. Furthermore, in a case where the length of a sheet in the conveyance direction is longer than the distance from the detection position of the multi-feeding detection sensor to the switching portion, the CPU 151 determines that the switching of the switching portion cannot be completed by the time when the leading edge of the sheet reaches the switching portion.

In addition, in a case where the CPU 151 determines that the sheet feeding apparatus 110 is connected to the third horizontal-conveyance path Ps23 of the sheet feeding apparatus 120, and that the switching of the switching portion cannot be completed by the time when the leading edge of multi-fed sheets reaches the switching portion, the CPU 151 conveys the multi-fed sheets to the sheet feeding apparatus 110, and outputs from the sheet feeding apparatus 120 to the sheet feeding apparatus 110 the information that the multi-feeding will not be performed in the sheet feeding apparatus 120. In this manner, if the multi-fed sheets are conveyed to the sheet feeding apparatus 110, the sheet feeding apparatus 110 can discharge the multi-fed sheets to the sheet discharging tray 119 by switching the switching portion FL1.

If multi-fed sheets are conveyed to the ink-jet head 201 that forms an image by using the ink-jet system, the ink-jet head 201 may be damaged by the multi-fed sheets. In the sheet feeding apparatus 120 or 110, however, the switching portion FL2 or FL1 is switched appropriately, so that the multi-fed sheets are not conveyed to the ink-jet head 201. As a result, the damage of the ink-jet head 201 can be prevented.

In the above-described first embodiment, the control is performed such that in a case where sheets from any one of the first to third sheet feeding trays 121 to 123 of the sheet feeding apparatus 120 are multi-fed, the multi-fed sheets are discharged to the sheet discharging tray 129 of the sheet feeding apparatus 120 or the sheet discharging tray 119 of the sheet feeding apparatus 110. However, the present disclosure is not limited to this. For example, sheets may be fed from any one of the first to third sheet feeding trays 131 to 133 of the sheet feeding apparatus 130. In this case, if the switching of the switching portion FL3 can be completed by the time when the leading edge of multi-fed sheets reaches the switching portion FL3, the multi-fed sheets are discharged to the sheet discharging tray 139 of the sheet feeding apparatus 130. If the switching of the switching portion FL3 cannot be completed by the time when the leading edge of multi-fed sheets reaches the switching portion FL3, the multi-fed sheets can be discharged to the sheet discharging tray 129 of the sheet feeding apparatus 120 or the sheet discharging tray 119 of the sheet feeding apparatus 110. Preferably, the multi-fed sheets are discharged to the sheet discharging tray 129 of the sheet feeding apparatus 120 because the possibility of the occurrence of jam increases as the multi-fed sheets are conveyed longer.

In a case where two or more sheet feeding apparatuses are connected with each other, side by side, in the conveyance direction, a conveyance portion of a downstream sheet-feeding apparatus serves as a first conveyance portion, a sheet discharging tray of the downstream sheet-feeding apparatus that serves as a discharging support portion serves as a first discharging-support portion. In addition, a second horizontal-conveyance path of the downstream sheet-feeding apparatus serves as a first conveyance path, a third horizontal-conveyance path of the downstream sheet-feeding apparatus serves as a second conveyance path, an error sheet-discharging path of the downstream sheet-feeding apparatus serves as a third conveyance path, and a switching portion of the downstream sheet-feeding apparatus serves as a first switching portion. In addition, a conveyance portion of an upstream sheet-feeding apparatus serves as a second conveyance portion, a sheet discharging tray of the upstream sheet-feeding apparatus that serves as a discharging support portion serves as a second discharging-support portion, a second horizontal-conveyance path of the upstream sheet-feeding apparatus serves as a fourth conveyance path, a third horizontal-conveyance path of the upstream sheet-feeding apparatus serves as a fifth conveyance path, an error sheet-discharging path of the upstream sheet-feeding apparatus serves as a sixth conveyance path, and a switching portion of the upstream sheet-feeding apparatus serves as a second switching portion.

### Second Embodiment

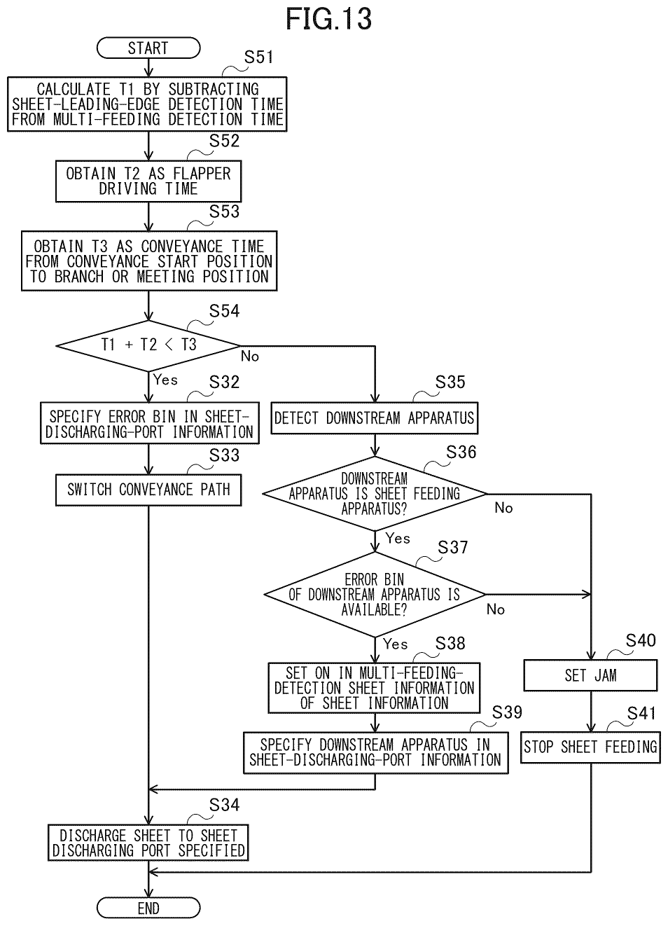

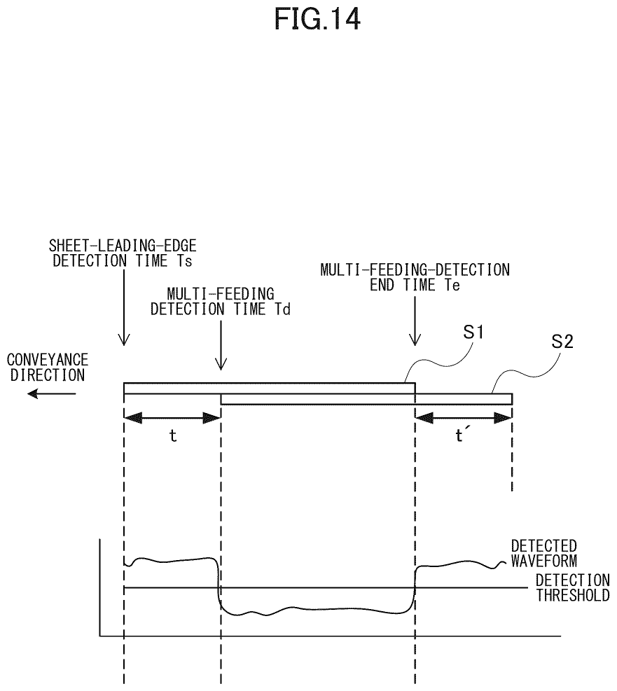

Next, a second embodiment will be described with reference to FIGS. 13 and 14. In the second embodiment, part of the first embodiment is changed. FIG. 13 is a flowchart illustrating the conveyance-path switch control of a sheet feeding apparatus of the second embodiment. FIG. 14 is a time chart illustrating a relationship between a waveform detected by the multi-feeding detection sensor and the time. Note that in the description of the second embodiment, a component identical to a component of the above-described first embodiment is given an identical symbol, and the description thereof will be omitted.

In the above-described first embodiment, the description has been made for the case where the CPU 151 determines based on the distance from the detection position of the multi-feeding detection sensor to the switching portion and on the length of the sheet, whether the switching of the switching portion can be completed by the time when the leading edge of multi-fed sheets reaches the switching portion. In the second embodiment, however, the CPU 151 calculates the time at which the leading edge of sheets on which the multi-feeding has been detected reaches the switching portion, and determines whether the time is earlier than the time at which the switching of the switching portion is completed. That is, by using the calculated time, the CPU 151 determines whether the switching of the switching portion can be completed by the time when the leading edge of multi-fed sheets reaches the switching portion. Note that for calculating the arrival time of the leading edge of a sheet, the position of the leading edge of the sheet can be calculated by using the conveyance speed of the sheet. Thus, it may be said that the CPU 151 determines based on the position of the leading edge of multi-fed sheets, whether the switching of the switching portion can be completed by the time when the leading edge of the multi-fed sheets reaches the switching portion.

Relationship between Waveform Detected by Multi-Feeding Detection Sensor and Time

Next, a relationship between a waveform detected by the multi-feeding detection sensor and the time will be described. As illustrated in FIG. 14, the second sheet S2 following the preceding first sheet S1 is conveyed, overlapped with the first sheet S1. That is, the second sheet S2 is conveyed, multi-fed. In a case where the sheets S1 and S2 are conveyed, shifted from each other, a sheet-leading-edge detection time Ts is a time at which the leading edge of the sheet S1 passes the detection position of the multi-feeding detection sensor, and a multi-feeding detection time Td is a time at which the leading edge of the sheet S2 reaches the detection position of the multi-feeding detection sensor. In a case where an ultrasonic multi-feeding-detection sensor is used, if the sheets are conveyed, shifted from each other, the waveform of an overlapping portion of the sheets detected by the sensor decreases in level. Thus, if the level of the waveform becomes lower than a predetermined threshold, the CPU 151 determines the occurrence of multi-feeding.

A multi-feeding shift time t that corresponds to the amount of shift between the multi-fed sheets S1 and S2 can be calculated by subtracting the sheet-leading-edge detection time Ts from the multi-feeding detection time Td. In other words, the multi-feeding shift time t is a length of time from the time when the leading edge of the sheet S1 is detected, to the time when the multi-feeding is detected. The multi-feeding shift time t corresponds to a conveyance time t′ by which the conveyance time is extended because the conveyance length of the total of the multi-fed sheets S1 and S2 becomes larger than the conveyance length of the sheet S1. In short, at the multi-feeding detection time Td at which the multi-feeding detection sensor detects the leading edge of the sheet S2, the leading edge of the sheet S1 has moved from the detection position of the multi-feeding detection sensor by a distance obtained by multiplying the conveyance speed with the multi-feeding shift time t, and has reached a position separated from the detection position by the distance.

### Conveyance-Path Switch Control

Next, the control of the sheet feeding apparatus of the second embodiment, especially the conveyance-path switch control of the second embodiment, will be described with reference to FIG. 13. In the conveyance-path switch control of the second embodiment, time information stored in the conveyance-route management table illustrated in FIG. 7 is used. Note that the conveyance-path switch control of the second embodiment differs from the conveyance-path switch control of the first embodiment (see FIG. 10) in the steps S51 to S54, and the other steps of the conveyance-path switch control of the second embodiment are substantially the same as those of the conveyance-path switch control of the first embodiment.

If the CPU 151 proceeds to Step S15 in the above-described conveyance-path switch control (see FIG. 9), then the CPU 151 starts the conveyance-path switch control of the second embodiment. Then the CPU 151 measures how far the leading edge of the sheet S1 (or the sheet S3) has moved in the conveyance path in the sheet feeding apparatus 120. That is, the CPU 151 calculates, as a first time T1, the time obtained by subtracting the multi-feeding detection time Td from the sheet-leading-edge detection time Ts (S51). The sheet-leading-edge detection time Ts is a time at which the multi-feeding detection sensor SN21, SN22, or SN23 detects the leading edge of the sheet S1 (or the sheet S3), and the multi-feeding detection time Td is a time at which the multi-feeding detection sensor SN21, SN22, or SN23 detects the multi-feeding after detecting the leading edge of the sheet S1 (or the sheet S3). Then the CPU 151 obtains, as a second time T2, a switching-portion driving time required for switching the switching portion FL2 (S52). The CPU 151 obtains the time required for switching the switching portion FL2, by referring to a value stored in the ROM 153 of the control portion 150. Then the CPU 151 calculates, as a third time T3, a conveyance time from a conveyance start position of a sheet to the error-bin branch point P5 (S53). The conveyance start position is the position of the downstream edge of one of the first to third sheet feeding trays 121 to 123. Note that since each of the multi-feeding detection sensors SN21, SN22, and SN23 is disposed in the vicinity of the downstream edge of a corresponding one of the first to third sheet feeding trays 121 to 123, the detection position of one of the multi-feeding detection sensors SN21, SN22, and SN23 may be the conveyance start position of the sheet. In addition, the error-bin branch point (i.e., a branch or meeting position) P5 may be the position of the switching portion FL2. The third time T3, which is the conveyance time from the conveyance start position of the sheet to the error-bin branch point P5, can be obtained from the above-described conveyance-route management table illustrated in FIG. 7. The CPU 151 can determine the information necessary for the CPU 151 to obtain, from the sheet-feeding tier information D03 contained in the sheet information list and the information on the error-bin branch point.

Then the CPU 151 determines whether to switch the conveyance path for the sheet S1 or S3 on which the multi-feeding has been detected (S54). In the second embodiment, the CPU 151 calculates the time required for completing the switching of the conveyance path, by adding the second time T2 to the above-described first time T1; and compares the time with the third time T3, which is a conveyance time from the sheet-feeding start position to the error-bin branch point P5. The comparison is expressed by the following numerical expression:

T1+T2<T3.

As a result of the comparison of the time, if the time, T1+T2, for completing the switching of the conveyance path is shorter than the third time T3, then the CPU 151 determines that the switching of the switching portion FL2 can be completed by the time when the leading edge of the sheet S1 or S3 reaches the switching portion FL2 (S54: Yes). That is, the CPU 151 determines that the multi-fed sheets S1 and S2 can be discharged to the sheet discharging tray 129, and proceeds to Step S32.

In this case, the CPU 151 specifies the error bin (i.e., the sheet discharging port 125) in the sheet-discharging-port information D08 (S32). In this manner, the CPU 151 switches the switching portion FL2 from the first position that is an initial position, to the second position at a timing earlier by a predetermined time than the time when the leading edge of the sheet S1 reaches the error-bin branch point (P5). That is, the CPU 151 switches the conveyance path (S33). In addition, the CPU 151 drives conveyance rollers of the error sheet-discharging path Ps24 extending to the sheet discharging port 125 (i.e., the sheet discharging tray 129) specified in the sheet-discharging-port information D08 (S34). In this manner, the CPU 151 discharges the sheets S1 and S2 to the sheet discharging tray 129 of the sheet feeding apparatus 120, as illustrated in FIG. 12. With this operation, the CPU 151 ends the conveyance-path switch control.

On the other hand, if the time, T1+T2, for completing the switching of the conveyance path is longer than the third time T3, then the CPU 151 determines that the switching of the switching portion FL2 cannot be completed by the time when the leading edge of the sheet S1 or S3 reaches the switching portion FL2 (S54: No). That is, the CPU 151 determines that the sheets S1 and S2 cannot be discharged to the sheet discharging tray 129 even if the CPU 151 drives the switching portion FL2, and proceeds to Step S35.

If the CPU 151 proceeds to Step S35, then the CPU 151 checks an apparatus disposed downstream in the conveyance direction and connected to the sheet feeding apparatus 120. The CPU 151 communicates with the sheet feeding apparatuses 110 and 130 adjacent to the sheet feeding apparatus 120, via the unit I/F 158 (see FIG. 5). Thus, in this process, the CPU 151 obtains connection detection information and a sheet-feeding-apparatus ID assigned to a corresponding sheet feeding apparatus. Then the CPU 151 determines based on the connection detection information obtained in Step S35 whether the adjacent sheet feeding apparatus 110, disposed downstream in the conveyance direction, is connected to the sheet feeding apparatus 120 (S36). Specifically, if the CPU 151 can obtain the connection detection information, and the sheet-feeding-apparatus ID is smaller than the sheet-feeding-apparatus ID of the sheet feeding apparatus that includes the CPU 151, then the CPU 151 determines that the sheet feeding apparatus 110 is disposed downstream and connected to the sheet feeding apparatus 120 (S36: Yes), and proceeds to Step S37. On the other hand, if the CPU 151 cannot obtain the connection detection information, or the sheet-feeding-apparatus ID is larger than the sheet-feeding-apparatus ID of the sheet feeding apparatus that includes the CPU 151 even though the CPU 151 can obtain the connection detection information, then the CPU 151 determines that the print portion 200 is disposed downstream and connected to the sheet feeding apparatus 120, and that the sheet feeding apparatus 110 is not connected to the sheet feeding apparatus 120 (S36: No). In this case, the CPU 151 proceeds to Step S40.

If the CPU 151 proceeds to Step S37, then the CPU 151 determines whether the error bin (i.e., the error sheet-discharging path Ps14 and the sheet discharging tray 119) of the downstream sheet feeding apparatus 110, which is adjacent to the sheet feeding apparatus 120, is available (S37). Specifically, the CPU 151 obtains, via the unit I/F 158, the state of the error bin of the downstream sheet feeding apparatus 110 that is adjacent to the sheet feeding apparatus 120; and proceeds to Step S38 if the CPU 151 determines that the error bin of the downstream sheet feeding apparatus 110 is available (S37: Yes). On the other hand, if the CPU 151 determines that the error bin of the downstream sheet feeding apparatus 110 is unavailable (S37: No), then the CPU 151 proceeds to Step S40. The error bin of the downstream sheet feeding apparatus 110 is unavailable, for example, in a case where the error bin is in a state where sheets are fully stacked on the sheet discharging tray 119, or where sheets cannot be fed due to the occurrence of jam in the error sheet-discharging path Ps14.

If the CPU 151 proceeds to Step S38, then the CPU 151 sets ON in the multi-feeding-detection sheet information D10 of the sheet information, specifies the sheet discharging port EX1 in the sheet-discharging-port information D08 of the sheet information (S39), and proceeds to Step S34. In this case, the CPU 151 notifies the downstream sheet feeding apparatus 110, which is adjacent to the sheet feeding apparatus 120, of the multi-feeding-detection sheet information D10 via the unit I/F 158. Note that the CPU 151 may notifies the downstream sheet feeding apparatus 110 of the sheet information itself, or of only the sheet ID information D01 and the multi-feeding-detection sheet information D10 of the sheet information. Then the CPU 151 drives conveyance rollers of the conveyance path extending to the sheet discharging port EX1 of the sheet feeding apparatus 120 specified in the sheet-discharging-port information D08 (S34). In this manner, the CPU 151 discharges the sheets S3 and S4 from the sheet feeding apparatus 120 to the sheet feeding apparatus 110, and to the sheet discharging tray 119 of the sheet feeding apparatus 110, as illustrated in FIG. 12. With this operation, the CPU 151 ends the conveyance-path switch control.

In addition, as described above, if the downstream apparatus is not the sheet feeding apparatus 110 but the print portion 200 (S36: No), or the error bin is unavailable even though the downstream apparatus is the sheet feeding apparatus 110 (S37: No), then the CPU 151 proceeds to Step S40. If the CPU 151 proceeds to Step S40, then the CPU 151 sets jam information for the sheets S3 and S4 that are being conveyed. Then the CPU 151 stops the driving of the conveyance rollers of the sheet feeding apparatus 120, that is, stops the feeding of sheets performed by the sheet feeding apparatus 120 (S41). With this operation, the CPU 151 ends the conveyance-path switch control.

### Summary of Second Embodiment

As described above, also in the sheet feeding apparatus 120 of the second embodiment, in a case where the multi-feeding is detected by the multi-feeding detection sensor SN21, SN22, or SN23, the CPU 151 determines whether the switching of the switching portion FL2 can be completed by the time when the leading edge of the sheet S1 reaches the switching portion FL2. In addition, if the CPU 151 determines that the switching of the switching portion FL2 can be completed by the time when the leading edge of the sheet S1 reaches the switching portion FL2, the CPU 151 switches the switching portion FL2 to the second position. With this operation, the CPU 151 guides the multi-fed sheets S1 and S2 to the sheet discharging tray 129. If the CPU 151 determines that the switching of the switching portion FL2 cannot be completed by the time when the leading edge of the sheet S3 reaches the switching portion FL2, the CPU 151 does not switch the switching portion FL2, and guides the sheets S3 and S4 to the third horizontal-conveyance path Ps23. With this operation, in a case where the multi-fed sheets S3 and S4 cannot be discharged to the sheet discharging tray 129, the CPU 151 discharges the sheets S3 and S4 to the downstream sheet feeding apparatus 110. If the multi-fed sheets S3 and S4 are conveyed in the second horizontal-conveyance path Ps12, the sheet feeding apparatus 110 switches the switching portion FL1 to the second position, and guides the sheets S3 and S4 to the sheet discharging tray 119. With this operation, the sheet feeding apparatus 110 can guide the multi-fed sheets S3 and S4 to the sheet discharging tray 119. Thus, the occurrence of jam can be prevented even in a case where the multi-feeding is detected, and where the switching of the switching portion FL2 cannot be completed by the time when the leading edge of the sheet S3 reaches the switching portion FL2.

In addition, in the second embodiment, the CPU 151 determines whether the switching of the switching portion FL2 can be completed by the time when the leading edge of the sheet S1 or S3 reaches the switching portion FL2, depending on the position of the leading edge of the sheet S1 or S3 located when the multi-feeding is detected by the multi-feeding detection sensor SN21, SN22, or SN23. In other words, the CPU 151 determines whether the switching of the switching portion FL2 can be completed by the time when the leading edge of the sheet S1 or S3 reaches the switching portion FL2, depending on the first time T1 from when the leading edge of the sheet S1 or S3 is detected by the multi-feeding detection sensor SN21, SN22, or SN23, until when the multi-feeding is detected by the multi-feeding detection sensor SN21, SN22, or SN23. Specifically, in a case where the sum of the first time T1 from when the leading edge of the sheet S1 or S3 is detected by the multi-feeding detection sensor SN21, SN22, or SN23, until when the multi-feeding is detected by the multi-feeding detection sensor SN21, SN22, or SN23, and the second time T2 required for switching the switching portion FL2 is shorter than the third time T3 required for conveying the sheet S1 or S3 from the multi-feeding detection sensor SN21, SN22, or SN 23 to the switching portion FL2, the CPU 151 determines that the switching of the switching portion FL2 can be completed by the time when the leading edge of the sheet S1 reaches the switching portion FL2. In addition, in a case where the sum of the first time T1 and the second time T2 is longer than the third time T3, the CPU 151 determines that the switching of the switching portion FL2 cannot be completed by the time when the leading edge of the sheet S3 reaches the switching portion FL2.

Since the other configuration, operations, and effects of the second embodiment are the same as those of the above-described first embodiment, the description thereof will be omitted.

The present invention can prevent the occurrence of jam even in a case where the multi-feeding is detected, and where the switching of the switching portion cannot be completed by the time when the leading edge of the first sheet reaches the switching portion.

### OTHER EMBODIMENTS

In the above-described first and second embodiments, in a case where the multi-feeding is detected in the sheet feeding apparatus 120, the multi-fed sheets are discharged to the sheet discharging tray 129 or the sheet discharging tray 119 of the sheet feeding apparatus 110. However, the present disclosure is not limited to this configuration. That is, the present disclosure is applicable to any configuration as long as multi-fed sheets are conveyed, in the configuration, to a portion other than the portion to which normal sheets are conveyed. For example, in a case where the sheet feeding is started from the sheet feeding apparatus 110 and multi-fed sheets cannot be discharged to the sheet discharging tray 119, the sheets may be discharged toward the sheet discharging port 301 of the fixing portion 300. Similarly, in a case where the sheet feeding is started from the sheet feeding apparatus 110 and multi-fed sheets cannot be discharged to the sheet discharging tray 119, the sheets may be discharged toward the sheet discharging port 501 of the reversing portion 500. In addition, in a case where sheets are conveyed from an upstream apparatus to the fixing portion 300 and the sheets cannot be discharged to the sheet discharging port 301, the sheets may be discharged toward the sheet discharging port 501 of the reversing portion 500. Thus, the destination to which normal (acceptable) sheets are conveyed is not limited to the image forming portion.

In the first embodiment, the CPU 151 determines whether the switching of the switching portion can be completed, depending on the length of a sheet; in the second embodiment, the CPU 151 determines whether the switching of the switching portion can be completed, depending on the time for managing the position of a sheet. However, the present disclosure is not limited to this. For example, the position of a sheet may be managed by using the time that is counted from a reference time (e.g., the time counted from when power is turned on, or the time counted from a time specified for feeding a sheet), and the CPU 151 may determine whether the switching of the switching portion can be completed, depending on the time. In another case, the position of a sheet may be managed by using the coordinates at which the sheet is located in the apparatus, and the CPU 151 may determine whether the switching of the switching portion can be completed, depending on the coordinates and the conveyance speed. In another case, a sensor may be disposed in the vicinity of the switching portion and upstream of the switching portion in the conveyance direction, for detecting the leading edge of a sheet, and the CPU 151 may determine whether the switching of the switching portion can be completed, depending on whether the sensor has detected the leading edge of a sheet.

In addition, since the image forming system 1 described in the first and second embodiments is one example, the system to which the present disclosure is applied may be any system as long as the system has a configuration for conveying sheets and causing the switching portion to switch the conveyance path. In particular, the system to which the present disclosure is applied is not limited to a system in which the image forming portion has an ink-jet system. For example, the system to which the present disclosure is applied may be a system in which the image forming portion has an electrophotographic system.

The present disclosure may be embodied by providing a program, which achieves one or more functions of the above-described embodiments, to a system or an apparatus via a network or a storage medium, and by causing one or more processors of the system or the apparatus to read and execute the program. In addition, the present disclosure may be embodied by a circuit (for example, an ASIC) that achieves one or more functions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-035940, filed Mar. 8, 2024, which is hereby incorporated by reference herein in its entirety.

What is claimed is:

1. A sheet conveyance apparatus comprising:
a conveyance portion configured to convey a sheet;
a discharging support portion configured to support the sheet discharged;
a switching portion configured to be switched between a first position and a second position, the first position being a position at which the switching portion guides the sheet conveyed in a first conveyance path by the conveyance portion, to a second conveyance path, the second position being a position at which the switching portion guides the sheet conveyed in the first conveyance path by the conveyance portion, to a third conveyance path configured to convey the sheet to the discharging support portion;
a support portion configured to support a plurality of sheets;
a feeding portion configured to feed the sheets supported by the support portion to the first conveyance path;
a taking-in port configured to receive the sheet and guide the sheet to the first conveyance path;
a multi-feeding detection portion disposed upstream of the switching portion in a sheet conveyance direction and downstream of the support portion in the sheet conveyance direction and configured to detect multi-feeding in which a first sheet and a second sheet that follows the first sheet overlap with each other; and
a control portion configured to control the switching portion,
wherein in a case where the multi-feeding is detected by the multi-feeding detection portion, based on the control portion determining that switching of the switching portion has been completed before a leading edge of the first sheet reaches the switching portion, the control portion is configured to switch the switching portion to the second position and guide the first sheet and the second sheet to the discharging support portion,
wherein in the case where the multi-feeding is detected by the multi-feeding detection portion, based on the control portion determining that the switching of the switching portion has not been completed before the leading edge of the first sheet reaches the switching portion, the control portion is configured not to switch the switching portion and guide the first sheet and the second sheet to the second conveyance path, and
wherein in a case where multi-fed first and second sheets are conveyed into the first conveyance path through the taking-in port, the control portion is configured to switch the switching portion to the second position and guide the first sheet and the second sheet to the discharging support portion.

2. The sheet conveyance apparatus according to claim 1,
wherein in a case where a length of the first sheet in the sheet conveyance direction is shorter than a distance from a detection position of the multi-feeding detection portion to the switching portion, the control portion is configured to determine that the switching of the switching portion has been completed before the leading edge of the first sheet reaches the switching portion, and
wherein in a case where the length of the first sheet in the sheet conveyance direction is longer than the distance from the detection position of the multi-feeding detection portion to the switching portion, the control portion is configured to determine that the switching of the switching portion has not been completed before the leading edge of the first sheet reaches the switching portion.

3. The sheet conveyance apparatus according to claim 1, wherein the control portion is configured to determine whether the switching of the switching portion has been completed before the leading edge of the first sheet reaches the switching portion depending on a position of the leading edge of the first sheet in a case where the multi-feeding is detected by the multi-feeding detection portion.

4. The sheet conveyance apparatus according to claim 1,
wherein in a case where a sum of a first time and a second time is shorter than a third time, the first time being a time from when the leading edge of the first sheet is detected by the multi-feeding detection portion until when the multi-feeding is detected by the multi-feeding detection portion, the second time being required for switching the switching portion, the third time being required for conveying the first sheet from the multi-feeding detection portion to the switching portion, the control portion is configured to determine that the switching of the switching portion has been completed before the leading edge of the first sheet reaches the switching portion, and
wherein in a case where the sum of the first time and the second time is longer than the third time, the control portion is configured to determine that the switching of the switching portion has not been completed before the leading edge of the first sheet reaches the switching portion.

5. The sheet conveyance apparatus according to claim 1, wherein in the case where the multi-feeding is detected by the multi-feeding detection portion, and in a case where the control portion determines that another sheet conveyance apparatus is connected to the second conveyance path and that the switching of the switching portion has not been completed before the leading edge of the first sheet reaches the switching portion, the control portion is configured to convey the first sheet and the second sheet to the another sheet conveyance apparatus and output information of the multi-feeding to the another sheet conveyance apparatus.

6. The sheet conveyance apparatus according to claim 1, wherein in the case where the multi-feeding is detected by the multi-feeding detection portion, and in a case where the control portion determines that another sheet conveyance apparatus is not connected to the second conveyance path and that the switching of the switching portion has not been completed before the leading edge of the first sheet reaches the switching portion, the control portion is configured to stop conveyance of the sheet by the conveyance portion.

7. The sheet conveyance apparatus according to claim 6, wherein in a case where the control portion stops the conveyance of the sheet by the conveyance portion, the control portion is configured to output information of occurrence of a jam.

8. The sheet conveyance apparatus according to claim 5, wherein in the case where the multi-feeding is detected by the multi-feeding detection portion, in a case where the control portion determines that the another sheet conveyance apparatus is connected to the second conveyance path and that the switching of the switching portion has not been completed before the leading edge of the first sheet reaches the switching portion, and in a case where the control portion determines that the first sheet and the second sheet are not able to be conveyed to the another sheet conveyance apparatus, the control portion is configured to stop conveyance of the sheet by the conveyance portion.

9. The sheet conveyance apparatus according to claim 8, wherein in a case where the control portion stops the conveyance of the sheet by the conveyance portion, the control portion is configured to output information of occurrence of a jam.

10. The sheet conveyance apparatus according to claim 1, wherein the second conveyance path is a conveyance path for conveying the sheet to an image forming portion configured to form an image on the sheet via another sheet conveyance apparatus.

11. The sheet conveyance apparatus according to claim 1, wherein the second conveyance path is a conveyance path for conveying the sheet to an image forming portion configured to form an image on the sheet not via another sheet conveyance apparatus.

12. The sheet conveyance apparatus according to claim 10, wherein the image forming portion is configured to form the image by using an ink-jet system.

13. A sheet conveyance apparatus connected to another sheet conveyance apparatus, the another sheet conveyance apparatus including:
a first conveyance portion configured to convey a sheet,
a first discharging support portion configured to support the sheet discharged, and
a first switching portion configured to be switched between a first position and a second position, the first position being a position at which the first switching portion guides the sheet conveyed in a first conveyance path by the first conveyance portion, to a second conveyance path, the second position being a position at which the first switching portion guides the sheet conveyed in the first conveyance path by the first conveyance portion, to a third conveyance path configured to convey the sheet to the first discharging support portion,
the sheet conveyance apparatus comprising:
a second conveyance portion configured to convey the sheet;
a second discharging support portion configured to support the sheet discharged;
a second switching portion configured to be switched between a third position and a fourth position, the third position being a position at which the second switching portion guides the sheet conveyed in a fourth conveyance path by the second conveyance portion, to a fifth conveyance path connected to the first conveyance path, the fourth position being a position at which the second switching portion guides the sheet conveyed in the fourth conveyance path by the second conveyance portion, to a sixth conveyance path configured to convey the sheet to the second discharging support portion;
a support portion configured to support a plurality of sheets;
a feeding portion configured to feed the sheets supported by the support portion to the fourth conveyance path;
a multi-feeding detection portion disposed upstream of the second switching portion in a sheet conveyance direction and configured to detect multi-feeding in which a first sheet and a second sheet that follows the first sheet overlap with each other; and
a control portion configured to control the second switching portion,
wherein in a case where the multi-feeding is detected by the multi-feeding detection portion, based on the control portion determining that switching of the second switching portion has been completed before a leading edge of the first sheet reaches the second switching portion, the control portion is configured to switch the second switching portion to the fourth position and guide the first sheet and the second sheet to the second discharging support portion, and
wherein in the case where the multi-feeding is detected by the multi-feeding detection portion, based on the control portion determining that the switching of the second switching portion has not been completed before the leading edge of the first sheet reaches the second switching portion, the control portion is configured not to switch the second switching portion, switch the first switching portion to the second position, and guide the first sheet and the second sheet to the first discharging support portion.

14. An image forming system comprising:
the sheet conveyance apparatus according to claim 1; and
an image forming apparatus configured to form an image on a sheet conveyed from the sheet conveyance apparatus.
